(19) United States
(12) Patent Application Publication
(10) Pub. No.: US 2007/0050682 A1
(43) Pub. Date: Mar. 1, 2007

(54) Processor and debugging device

(76) Inventors: Akira Takuma, Osaka (JP); Kohsaku Shibata, Osaka (JP)

Correspondence Address: MCDERMOTT WILL & EMERY LLP, 600 13TH STREET, NW, WASHINGTON, DC, 20005-3096, US

(21) Appl. No.: 11/509,797

(22) Filed: Aug. 25, 2006

(30) Foreign Application Priority Data
Aug. 26, 2005 (JP) 2005-245645

(51) Int. Cl. G06F 11/00

(52) U.S. Cl. 714/45

(57) ABSTRACT

A processor according to the present invention is capable of executing instructions in parallel, the processor further executing a string of instructions consisting of a plurality of instructions allocated at continuous addresses as an execution unit, comprising an instruction analyzer, an instruction executor and an instruction canceling unit. The instruction analyzer comprising debug instruction detectors for detecting a debug instruction which generates debug interruption, the instruction detectors of the same number as the instructions executable in parallel by the processor is provided. The instruction executor for executing a group of instructions comprising at least one of the instructions that is included in the same string of the instructions as the detected debug instruction and allocated at an address of a lower-order position than the detected debug instruction when the debug instruction is detected by the instruction analyzer, and an instruction canceller for canceling execution of a group of instructions comprising at least one of the instructions that is included in the same string of the instructions as the detected debug instruction and allocated at an address of a higher-order position than the detected debug instruction when the debug instruction is detected by the instruction analyzer.

### BACKGROUND OF THE INVENTION

1. Field of the Invention

The present invention relates to a processor for executing a plurality of instructions in parallel.

2. Description of the Related Art

In a conventional debugging device comprising a processor having an architecture for deciding instructions that are statically executable in parallel, where is a break point in a string of instructions that is logically and physically executable in parallel, can be displayed when all of the strings of instructions are displayed. Further, the break point can be set at the instruction located on the top of the string of instructions that are executable in parallel or at the top of a container in which each of groups of instructions constituting a part of the string of instructions is divided into a fixed length. The group of instructions described here means an instruction or a plurality of serial instructions constituting the string of instructions that is executable in parallel.

However, in the conventional debugging device, it was difficult to set the break point at any arbitrary instruction in the string of instructions that is executable in parallel in any of the following states.

The first state is a state where a boundary of the string of instructions logically executable in parallel (hereinafter, referred to as a parallel boundary), for example, is divided so as to be fixed to such a length as a 128-bit length due to restrictions resulting from the architecture of the processor. In this state, even if any of the instructions in the string of instructions is replaced with a debug instruction, the other instructions with the same dividing unit as that of the relevant instruction are also executed in parallel. The debug instruction is an instruction whose purport is to generate debug interruption.

In a source program shown in FIG. 9, for example, it is assumed that mechanical language codes shown in FIG. 10 are generated. A symbol “∥” denotes that an instruction with the symbol can be logically executed in parallel with an instruction in a subsequent row. When the break point is tried to be set at an instruction in a row number 10 shown in FIG. 9, an address “0x80000000” is obtained from a debug information, and an instruction “MOV R1, 1 ∥” at the address “0x80000000” is replaced with “BRK ∥” which is the debug instruction as shown in FIG. 11.

Because the BRK instruction is provided with the symbol “∥”, subsequent instructions “MOV R2, 2” and “MOV R3, 3” are possibly logically executed at the same time as the formation of the break point, and it is possible to halt under a state where instructions in 11th and 12th rows have also been executed regardless of having set the break point at the instruction in the row number 10 in the original source program.

The second state is a state where the parallel boundary is restricted to some patterns though it is not fixed based on the restrictions resulting from the architecture of the processor, and therefore, cannot be designated by any arbitrary instruction. In this state, even though any instruction in the string of sequences is tried to be replaced with the debug instruction, the other instructions based on the same dividing length as that of the relevant instruction are also executed in parallel when a position where the instruction is replaced with the debug instruction cannot be set at the parallel boundary due to the restricted patterns.

A specific example is described again referring to the example referred in the first state. Provided that a processor in which the parallel boundary can only be set every two or three instructions is used, even if the symbol “∥” Of the instruction “BRK ∥” is tried to be removed, it is not possible to set the parallel boundary because the instruction BRK itself is merely one instruction.

### SUMMARY OF THE INVENTION

Therefore, a main object of the present invention is to make possible to set a break point at an arbitrary instruction in a string of instructions that can be executed in parallel.

A processor according to the present invention for being able to execute instructions in parallel, and also further executing a string of instructions comprising a plurality of instructions at continuous addresses as an execution unit, comprises:

an instruction analyzer comprising debug instruction detectors for detecting a debug instruction which generates debug interruption, wherein the instruction detectors are provided as many as the instructions that is executable in parallel in the processor;

an instruction executor for executing a group of instructions comprising at least an instruction that is included in the same string of instructions to which the detected debug instruction belongs, and allocated at an address of a lower-order position than that of the detected debug instruction when the debug instruction is detected by the instruction analyzer; and

an instruction canceller for canceling execution of a group of instructions comprising at least an instruction that is included in the same string of instructions to which the detected debug instruction belongs, and allocated at an address of a higher-order position than that of the detected debug instruction when the debug instruction is detected by the instruction analyzer.

According to the foregoing constitution, the break point can be freely set at any of the instructions that is simultaneously executed by setting the break point based on the debug instruction. Further, an execution order associated from the addresses to which the instructions is allocated can be correctly repeated in the string of instructions simultaneously executed when the program is halted at the break point because the execution of the instructions subsequent to the set break point is cancelled.

A processor according to the present invention is a processor capable of executing instructions in parallel, the processor further executing a string of instructions comprising a plurality of instructions at continuous addresses as an execution unit, comprises:

an instruction analyzer comprising debug instruction detectors for detecting a debug instruction which generates debug interruption and the debug instruction detectors are provided as many as the instructions that is executable in parallel by the processor;

an instruction fetcher for fetching the string of instructions from outside;

an instruction part judger for judging whether or not a part of the string of instructions fetched by the instruction fetcher corresponds with a particular bit pattern;

an instruction nullifier for nullifying a group of instructions comprising at least one of the instructions allocated at an address of a higher-order position than the instruction consistent with the particular bit pattern when the instruction part judger judges that the string of instructions includes the instruction consistent with the particular bit pattern;

an instruction issuer for issuing the instruction consistent with the particular bit pattern and a group of instructions comprising at least one of the instructions at an address of a lower-order position than that of the instruction consistent with the particular bit pattern to the instruction analyzer when the instruction part judger judges that the instruction consistent with the particular bit pattern is present in the plurality of instructions; and

an instruction decoder for decoding an arbitrary instruction selected from the instructions consistent with the particular bit pattern as the debug instruction.

According to the foregoing constitution, the break point can be freely set at any of the instructions that is simultaneously executed by setting the break point based on the debug instruction. Further, an execution order associated from the addresses of the instructions can be correctly repeated in the string of instructions simultaneously executed when the program is halted at the break point because the execution of the instructions subsequent to the set break point is cancelled. Further, as it becomes unnecessary to provide the instruction canceller, the structure of the processor is effectively simplified.

Further, the foregoing problem can be solved by means of the following instruction execution control method if the debug instruction can be arranged at any arbitrary position as in the processor according to the present invention.

An instruction execution control method according to the present invention comprises:

a step of changing an instruction boundary in a string of instructions provided in a program operated by a processor capable of executing instructions in parallel and comprising a plurality of instructions logically executable in parallel; and

a step of setting a break point at any of the instructions constituting the string of instructions.

An instruction execution control method according to the present invention comprises:

a step of changing an instruction boundary in a string of instructions provided in a program operated by a processor capable of executing instructions in parallel and comprising a plurality of instructions logically executable in parallel; and

a step of selectively executing at least an arbitrary instruction in the string of instructions.

In the foregoing constitution, it is preferable that a group of instructions comprising at least one of the instructions subsequent to the arbitrary instruction at which the break point is set, are replaced with a group of instructions comprising at least one of the instructions that do not affect an operation result to be guaranteed when the group of instructions are executed. Thereby, such a restriction of the processor that the parallel boundary cannot be changed can be avoided. As the instruction for the replacement like this, there is an NOP instruction which merely serves to advance a program counter, and the instruction of this type does not affect the operation result to be guaranteed when the instruction is executed with a BRK instruction for breaking. Further, a similar effect can be obtained when any instruction other than the arbitrary instruction is replaced with such an instruction that does not affect the operation result to be guaranteed (the foregoing instruction for the replacement) when the instruction is executed.

An instruction execution control method according to the present invention comprises:

a step for changing an order of instructions within such a range that does not affect an operation result to be guaranteed in a string of instructions provided in a program operated by a processor capable of executing instructions in parallel and constituted with a plurality of instructions logically executable in parallel; and

a step of setting a break point at any of the instructions of the above-described instructions constituting the string of instructions.

According to the constitution, it can be avoided even if there is any restriction on a description position of the BRK instruction itself.

Thus, the instruction execution control method according to the present invention is capable of avoiding it even if there is any restrictions on a description position of an NOP instruction itself by changing the order of the instructions within such a range that does not affect the operation result to be guaranteed so that the arbitrary instruction can be step-executed in the processor capable of executing the instructions in parallel.

An instruction execution control method according to the present invention comprises:

a step of changing an order of instructions within such a range that does not affect an operation result to be guaranteed in a string of instructions provided in a program operated by a processor capable of executing instructions in parallel and constituted with a plurality of instructions logically executable in parallel; and

a step of selectively executing an arbitrary instruction in the string of instructions.

An instruction execution control method according to the present invention comprises:

a step for setting a break point at an arbitrary instruction in a string of instructions provided in a program operated by a processor capable of executing instructions in parallel and constituted a plurality of instructions logically executable in parallel;

a step of correcting a position at which the break point is set in accordance with restrictions of the processor;

a step of detecting whether or not the execution of the instruction is halted at the corrected break point; and

a step for software-emulating a group of instructions comprising at least one of the instructions located between the corrected break point and the break point before the correction when it is detected that the execution of the instruction is halted at the corrected break point. Accordingly, an operation result equal to the one when the execution of the instruction is halted at the position before the correction, can be obtained.

An instruction execution control method according to the present invention comprises:

a step for extracting an arbitrary instruction from a string of instructions provided in a program operated by a processor capable of executing instructions in parallel and constituted with a plurality of instructions logically executable in parallel; and

a step for software-emulating the extracted arbitrary instruction.

Accordingly, an operation result equal to the one when the arbitrary instruction is selectively executed, can be obtained.

The processor is generated from a source program. Further, it is preferable that a correlation between an execution statement of the source program and the string of instructions be extracted from a debug information in which the execution statement of the source program and an address position of the instruction are correlated to each other, and thereafter the arbitrary instruction be selected based on the extracted correlation. Thereby, the instructions can be executed in a same order as that of the execution statement after the execution statement of the source program and a string of instructions in a machine language are correlated to each other.

According to the present invention, the break point can be effectively set at any arbitrary instruction in such a debugging in the case of a processor where a program device for determining instructions logically executable in parallel is used at the time of conversion from the source program to the machine language program. Further, each instruction can be step-executed in the case of executing the debug in the same processor.

The processor capable of executing the instructions in parallel according to the present invention is applicable to an electronic device for which a high execution performance is demanded such as control devices of different types and a signal processing device. Such an advantage of the processor according to the present invention that the debug instruction can be freely allocated can be useful in software development for electronic devices. The debugging device according to the present invention is helpful when the break point is set at a string of instructions that is generated by a program conversion device and executable in parallel, and unit execution such as the step execution is operated. In the foregoing case, a degree of freedom similar to that of a debugging device in a processor for executing an instruction as a unit can be obtained. The present invention can also be applied to a processor such as a host computer and the like other than a built-in type.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 shows a data flow in the case where a program conversion device and a debugging device are combined.

FIG. 2 shows a specific example of the debugging device.

FIG. 3 shows the components for control constituting a debugging device according to a conventional technology.

FIG. 4 shows the components for control constituting a debugging device responding to parallel execution of instructions.

FIG. 5 shows a constituent example of a bit pattern of a 32-bit length instruction.

FIG. 6 shows a constituent example of a bit pattern of a 16-bit length instruction.

FIG. 7 shows an example of a bit pattern for synthesizing a parallel boundary of the 32-bit length instruction.

FIG. 8 shows an example of a bit pattern for synthesizing a parallel boundary of the 16-bit length instruction.

FIG. 9 shows an example of a source program.

FIG. 10 shows an example in which the source program shown in FIG. 9 is converted into an execution program including instructions executed in parallel.

FIG. 11 shows an example in which the forehead instruction of the execution program shown in FIG. 10 is replaced with a debug instruction according to the conventional technology.

FIG. 12 shows an example in which the forehead instruction of the execution program shown in FIG. 10 is replaced with the debug instruction according to a process flow shown in FIG. 22.

FIG. 13 shows an example in which the forehead instruction of the execution program shown in FIG. 10 is replaced with the debug instruction according to a process flow shown in FIG. 23.

FIG. 14 shows an example in which the forehead instruction of the execution program shown in FIG. 10 is replaced with the debug instruction according to a process flow shown in FIG. 24.

FIG. 15 shows an example in which a second instruction of the execution program shown in FIG. 10 is replaced with the debug instruction after an order of instructions is changed at a position of the second instruction according to a process flow shown in FIG. 25.

FIG. 16 shows an example in which the second instruction of the execution program shown in FIG. 10 is replaced with the debug instruction after the debug instruction is corrected at a position of the second instruction according to a process flow shown in FIG. 26.

FIG. 17 shows an example in which the forehead instruction of the execution program shown in FIG. 10 is replaced so as to realize step execution according to a process flow shown in FIG. 28.

FIG. 18 shows an example in which the forehead instruction of the execution program shown in FIG. 10 is replaced so as to realize the step execution according to a process flow shown in FIG. 29.

FIG. 19 shows an example in which the second instruction of the execution program shown in FIG. 10 is replaced so as to realize the step execution according to the process flow shown in FIG. 29.

FIG. 20 shows an example in which the second instruction of the execution program shown in FIG. 10 is replaced so as to realize the step execution according to the order change of the instructions in addition to the process flow shown in FIG. 29.

FIG. 21 shows a flow of an instruction replacing process according to the conventional technology.

FIG. 22 shows a flow of the instruction replacing process in the case where the parallel boundary can be changed and the post-replacement instruction can be executed in parallel.

FIG. 23 shows a flow of the instruction replacing process in the case where the parallel boundary cannot be changed.

FIG. 24 shows a flow of the instruction replacing process in the case where the parallel boundary can be changed but the post-replacement instruction cannot be executed in parallel.

FIG. 25 shows a flow of the instruction replacing process in the case where the order of the instructions capable of executing in parallel can be changed.

FIG. 26 shows a flow of the instruction replacing process in the case where software simulation is utilized.

FIG. 27 shows a flow of the step execution process.

FIG. 28 shows a flow in the case where the parallel boundary can be changed in S2003 shown in FIG. 27.

FIG. 29 shows a flow in the case where the parallel boundary cannot be changed in S2003 shown in FIG. 27.

FIG. 30 is a block diagram relating to a processor according to the present invention.

FIG. 31 is a block diagram of an instruction execution pipeline of a VLIW processor according to the conventional technology.

FIG. 32 is a block diagram of an instruction execution pipeline in a first preferred embodiment of the processor according to the present invention.

FIG. 33 is a block diagram of an instruction execution pipeline in a second preferred embodiment of the processor according to the present invention.

FIG. 34 is a block diagram of a cancellation signal generator in the first preferred embodiment of the processor according to the present invention.

FIG. 35 is a block diagram of an instruction execution controller in the first preferred embodiment of the processor according to the present invention.

FIG. 36 shows an example of a bit pattern of the instruction in the second preferred embodiment of the processor according to the present invention.

FIG. 37 shows an example of a bit pattern of the debug instruction in the second preferred embodiment of the processor according to the present invention.

### DETAILED DESCRIPTION OF THE INVENTION

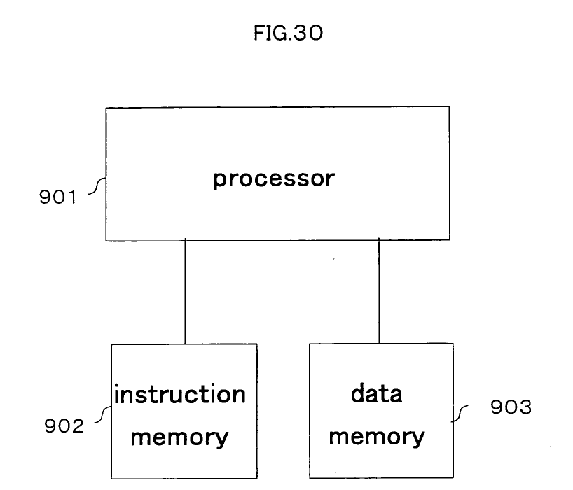

Hereinafter, preferred embodiments of the present invention are described referring to the drawings. FIG. 30 is a block diagram showing a relationship between a processor and a memory according to the present invention.

A processor 901 is connected to an instruction memory 902 and a data memory 903. The processor 901 fetches an instruction from the instruction memory 902 to execute the fetched instruction and thereby change an internal state of a register or the like of the processor 901 and contents of the data memory 903.

The processor 901 has the VLIW (Very Long Instruction Word) architecture for simultaneously executing a string of instructions comprising a plurality of instructions as an instruction packet. Hereinafter, the processor in which the VLIW architecture is adopted is called a VLIW processor.

Constitution of General Processor

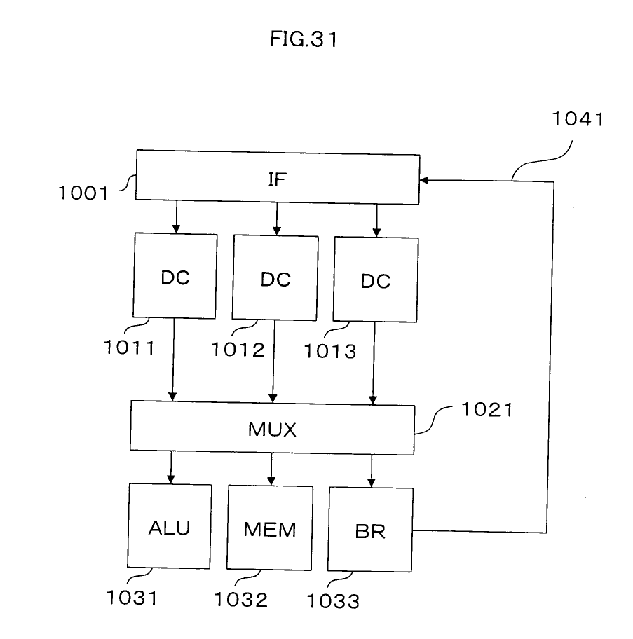

In order to clarify differences between the present invention and the conventional technology, a basic structure of the VLIW processor generally used is described. A block diagram shown in FIG. 31 is an example of an instruction execution pipeline in the conventional VLIW processor capable of executing three instructions in parallel as an instruction packet. However, any part that is not important in the present invention is omitted.

The processor comprises an instruction fetcher 101 for fetching the instruction from the instruction memory, instruction decoders 1011-1013 for decoding the fetched instruction, a multiplexer 1021 for selecting an operator in accordance with the decoded instruction, an ALU (Arithmetic and Logic Unit) 1031 for executing arithmetic and logical operations, a memory access unit 1032 for accessing the data memory, and a branch unit 1033 for changing the instruction to be fetched.

The respective instructions included in the instruction packet fetched by the instruction fetcher 1001 are separately decoded in parallel by the instruction decoders 1011-1013. At the time, the instruction at a lowest-order address in the instruction packet is decoded by the instruction decoder 1011, the instruction at a second-lowest-order address is decoded by the instruction decoder 1012, and the instruction at a highest-order address is decoded by the instruction decoder 1013.

The multiplexer 1021 selects the operators necessary for executing the respective instructions decoded by the instruction decoders 1011-1013, and transmits the respective instructions to the operators. In the VLIW processor, the respective instructions in the instruction packet (instruction string) are allocated based on the assumption that they are executed in parallel. Therefore, in the instructions in the same instruction packet, there is no duplication of the operators to be used and data dependency. As a result, the multiplexer 1021 has a very simple structure, which is a characteristic of the VLIW processor.

The ALU 1031, memory access unit 1032 and branch unit 1033 separately execute the instructions transmitted from the multiplexer 1021 in parallel.

When a debug instruction is executed in the branch unit 1033, a debug interruption signal 1041 is transmitted to the instruction fetcher 1001. The instruction fetcher 1001 then receives the debug interruption signal 1041 and fetches the instruction from an address designated as a debug interruption handler.

As is clear from the foregoing description, the VLIW processor can use the limited operator-related resource effectively though it is not provided with a complicated instruction scheduling function, and thereby execute the instructions in parallel.

However, the debug instruction cannot be allocated at the same instruction packet (instruction string) as the instruction wherein the branch unit 1033 is used because the debug instruction is executed in the branch unit 1033. Therefore, an arbitrary instruction cannot be replaced with the debug instruction when a break point for halting a program at an arbitrary position is set.

### First Preferred Embodiment of Processor According to the Present Invention

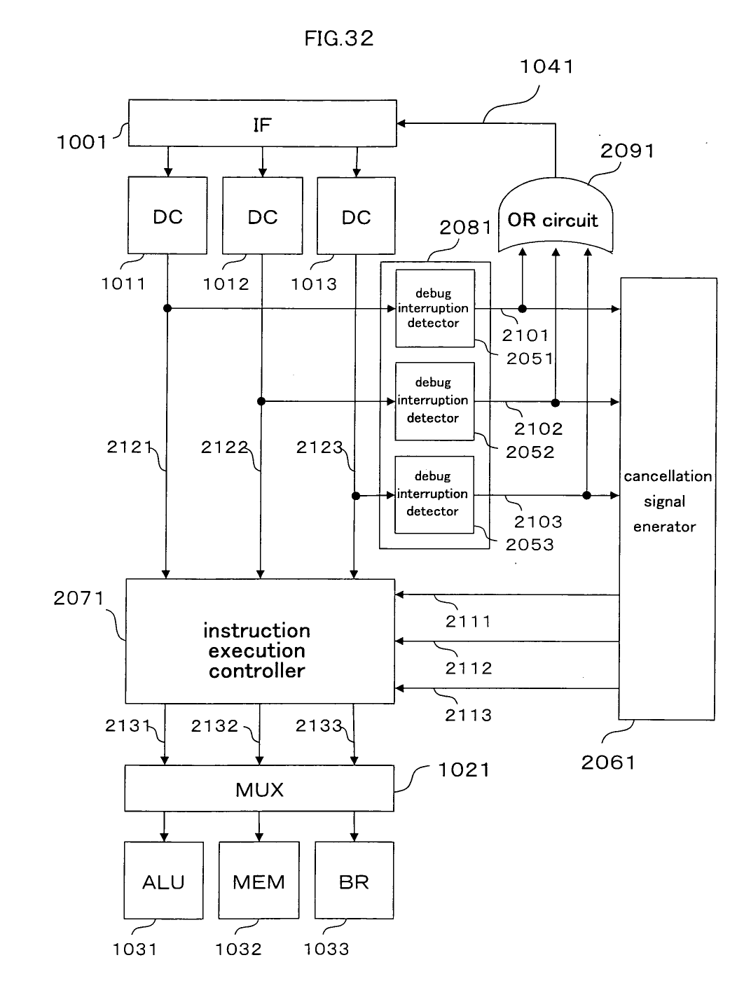

A first preferred embodiment of the processor 901 according to the present invention is described. FIG. 32 shows an example of an instruction execution pipeline in the VLIW processor according to the present invention. However, any component that is not important in the present invention is omitted.

In the first preferred embodiment, the processor 901 comprises the instruction fetcher 1001, instruction decoders 1011-1013, multiplexer 1021, ALU 1031, memory access unit 1032, and branch unit 1033, in a manner similar to the basic structure of the processor described earlier.

In the first preferred embodiment, the processor 901 further comprises a debug interruption decoder 2081, a cancellation signal generator 2061, an instruction execution controller 2071, and an OR circuit 2091. The debug interruption decoder 2081 comprises debug interruption detectors 2051-2053 for detecting whether or not an arbitrary instruction generates debug interruption. The cancellation signal generator 2061 generates cancellation signals 2111-2113 for canceling the execution of the instruction. The instruction execution controller 2071 nullifies the instruction to thereby cancel the execution of the instruction. The OR circuit 2091 operates a logical addition of the debug interruption signals 2101-2103 transmitted from the debug interruption detectors 2051-2053.

The debug interruption detectors 2051-2053 obtain instruction signals 2121-2123 which are decoding results of the instruction decoders 1011-1013, and judges whether or not the debug instructions in the obtained instruction signals 2121-2123 generate the debug interruption. The respective debug interruption detectors 2051-2053 output the debug interruption signals 2101-2103 based on judgment results obtained. More specifically, the debug interruption detectors 2051-2053 assert the instruction signals 2121-2123 when it is judged that the debug instructions generate the debug interruption, while negating the instruction signals 2121-2123 when it is judged that the relevant debug instructions do not generate the debug interruption.

The debug interruption signals 2101-2103 asserted by the debug interruption detectors 2051-2053 are merged by the OR circuit 2091 and inputted to the instruction fetcher 1001 as the debug interruption signal 1041. Thereby, the debug interruption can be generated in a manner similar to the conventional processor.

The debug interruption signals 2101-2103 are also supplied to the cancellation signal generator 2061. The cancellation signal generator 2061 asserts the cancellation signals 2111-2113 based on the supplied debug interruption signals 2101-2103. More specifically, in the case where the debug interruption signals 2101-2103 of the instruction allocated at an address in an arbitrary position are asserted, the corresponding cancellation signals 2111-2113 are asserted so that the execution of the relevant instruction and a group of instructions comprising at least one of the instructions at an address of a higher-order position than that of the relevant instruction is cancelled.

The instruction execution controller 2071 converts the instruction signals 2121-2123 corresponding to the asserted cancellation signals 2111-2113 into instruction signals indicating NOP (No Operation), and transmits the converted signals to the ALU 1031, memory access unit 1032 and branch unit 1033 as instruction signals 2131-2133. Thereby, the execution of the instruction corresponding to the asserted cancellation signals 2111-2113 is nullified.

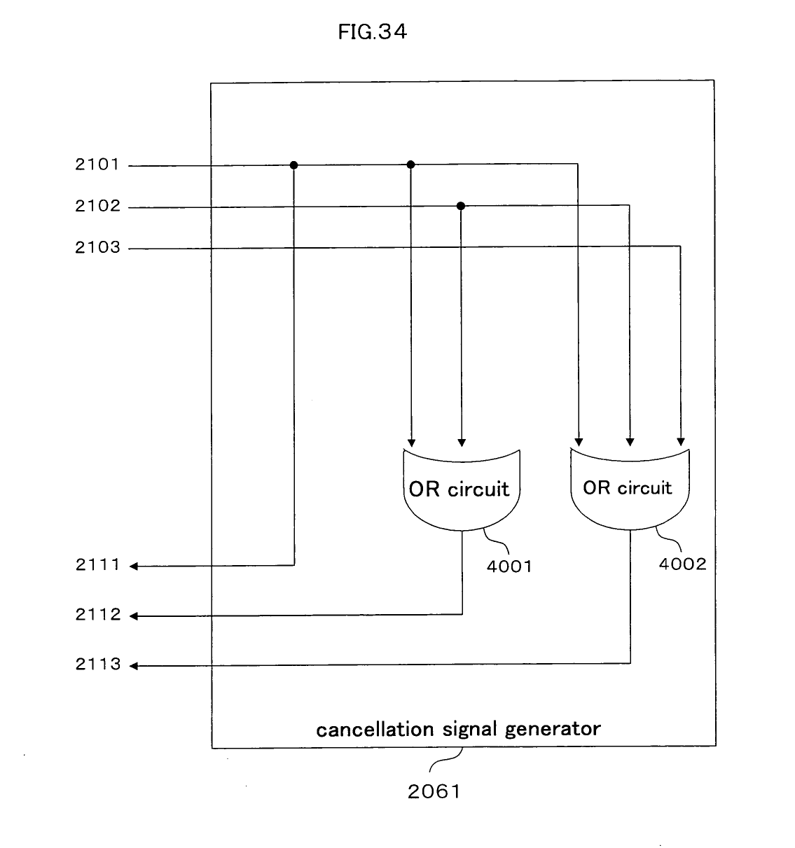

Referring to FIG. 34, the constitutions of the cancellation signal generator 2061 and the instruction execution controller 2071 are further described. FIG. 34 shows a detailed structure of the cancellation signal generator 2061.

The cancellation signal generator 2061 comprises OR circuits 4001-4002. The debug interruption signals 2101-2103 are inputted to the cancellation signal generator 2061. The debug interruption signal 2101 corresponds to the instruction allocated at an address of a lowest-order position in the instruction packet (instruction string). The debug interruption signal 2102 corresponds to the instruction allocated at an address of a second-lowest-order position in the instruction packet. The debug interruption signal 2103 corresponds to the instruction allocated at an address of a third-lowest-order position in the instruction packet.

The cancellation signal generator 2061 outputs the cancellation signals 2111-2113. The cancellation signal 2111 corresponds to the instruction allocated at the address of the lowest-order position in the instruction packet. The cancellation signal 2112 corresponds to the instruction allocated at the address of the second-lowest-order position in the instruction packet. The cancellation signal 2113 corresponds to the instruction allocated at the address of the third-lowest-order position in the instruction packet. The cancellation signal 2111 is generated from the debug interruption signal 2101. The cancellation signal 2112 is generated from a logical addition of the debug interruption signal 2101 inputted to the OR circuit 4001 and the debug interruption signal 2102. The cancellation signal 2112 is generated from the debug interruption signal 2101. The cancellation signal 2112 is generated from a logical addition of the debug interruption signal 2102 inputted to the OR circuit 4001 and the debug interruption signal 2103.

According to the foregoing constitution, in the case where the debug interruption is generated in the arbitrary instruction in the instruction packet, the cancellation signals corresponding to the instruction in which the debug interruption is generated and a group of instructions comprising at least one of the instructions allocated at the address of the higher-order position than that of the instruction, are asserted.

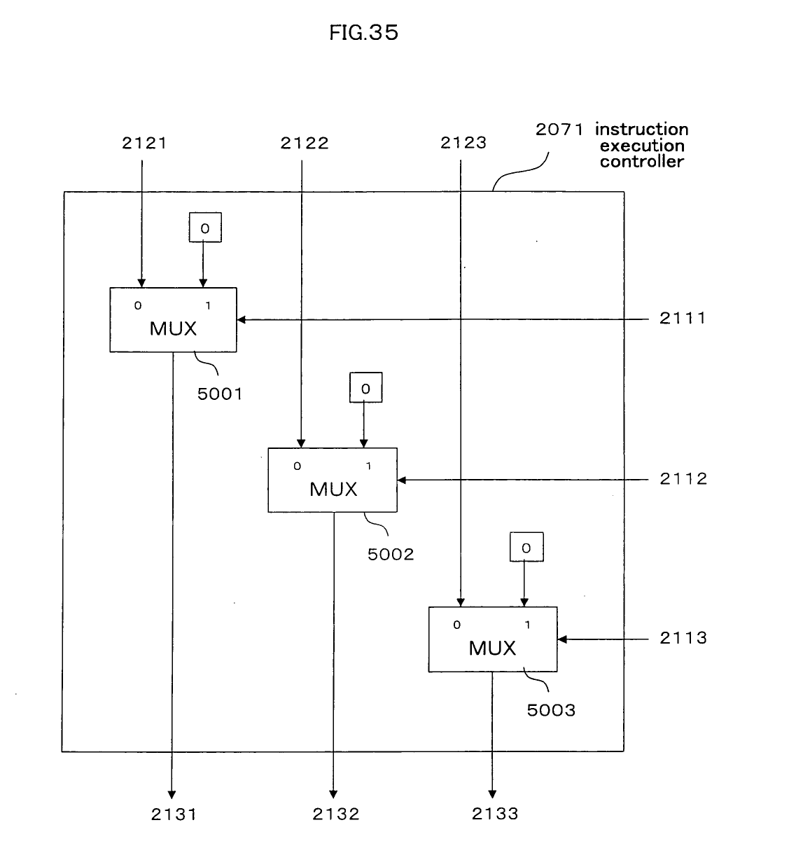

FIG. 35 shows a detailed structure of the instruction execution controller 2071. The instruction execution controller 2071 comprises multiplexers 5001-5003. The instruction signals 2121-2123 and the cancellation signals 2111-2113 are inputted to the instruction execution controller 2071. The instruction execution controller 2071 outputs the instruction signals 2131-2133.

The instruction signals 2121-2123 and a value “0” (NOP) are inputted to the multiplexers 5001-5003. The instruction signals 2121-2123 are supplied from outside of the instruction execution controller 2071. The value “0” (NOP) indicates an instructions signal corresponding to NOP, and can be generated inside the instruction execution controller 2071. The multiplexers 5001-5003 alternatively select any of the foregoing inputs based on the cancellation signals 2111-2113 and output the selection results. The multiplexers 5001-5003 select the instruction signals 2121-2123 when the cancellation signals 2111-2113 indicates the value “0”, while selecting the value “0” (NOP) when the cancellation signals show a value “1”, and then output the selection results as the instruction signals 2131-2133. The instruction signals 2131-2133 are outputted to the ALU 1031, memory access unit 1032, and branch unit 1033.

According to the foregoing constitution, in the case where the cancellation signals 2111-2113 corresponding to the arbitrary instruction are asserted, the instruction signals 2131-2133 corresponding to them are converted into the instruction signals corresponding to the NOP. Thereby, any particular instruction can be nullified based on the asserted cancellation signals.

According to the foregoing constitution described above, in the processor 901 according to the first preferred embodiment 1, when the debug instruction is decoded, the decoded debug instruction and the group of instructions comprising at least one of the instructions allocated at the address of the higher-order position than the debug instruction, are nullified. Therefore, the instruction execution resource such as the operator is prevented from running short no matter where in the instruction packet (instruction string) the debug instruction is allocated. In other words, restrictions on the execution of the debug instruction no longer exist, and the debug instruction can be allocated at any arbitrary position in the instruction packet. Accordingly, the arbitrary instruction can be replaced with the debug instruction when the break point is set to halt the program at any arbitrary position. Further, as the execution of the group of instructions comprising at least one of the instructions subsequent to the debug instruction in the instruction packet is cancelled, a relationship between the break point and the instruction execution is more intuitively grasped due to no execution of any instruction at the address of the higher-order position than the break point when the program is halted at the break point due to the generation of the debug interruption.

The number of the instructions capable of executing simultaneously is made to be three in the foregoing preferred embodiment in order to simplify the description. A similar constitution can be applied to a VLIW processor in which the number of the instructions that can be simultaneously executed is at least two, wherein it is obvious that a similar effect can be obtained.

### Second Preferred Embodiment of Processor According to the Present Invention

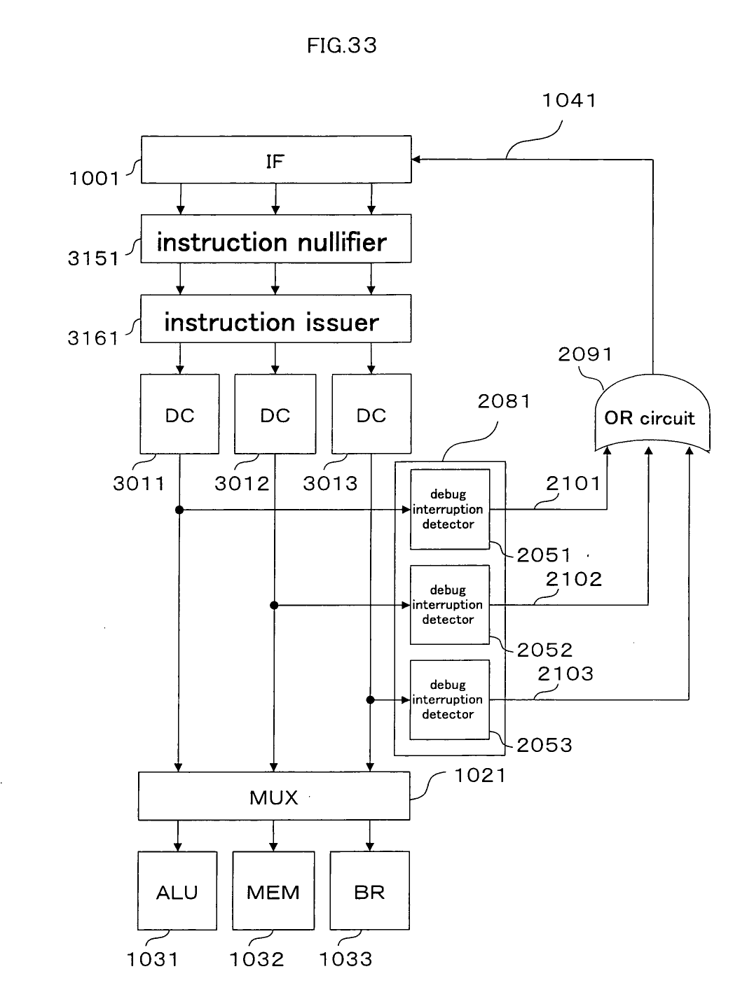

A second preferred embodiment of the processor 901 according to the present invention is described. FIG. 33 shows an example of an instruction execution pipeline in the VLIW processor according to the present invention. Any component that is not important in the present invention is omitted.

In the second preferred embodiment, the processor 901 comprises the instruction fetcher 1001, multiplexer 1021, ALU 1031, memory access unit 1032, branch unit 1033, debug instruction decoder 2081 with the debug interruption detectors 2051-2053, and OR circuit 2091, which are similar to the first preferred embodiment.

In the second preferred embodiment, the processor 901 further comprises an instruction nullifier 3151, an instruction issuer 3161, and instruction decoders 3011-3013. The instruction nullifier 3151 nullifies a group of instructions comprising at least one of the instructions allocated at an address of a higher-order position than an instruction in which a particular bit pattern is detected among the instructions fetched by the instruction fetcher 1001. The instruction issuer 3161 selectively issues the effective instruction to the instruction decoders 3011-3013. The instruction decoders 3011-3013 decode the instruction issued by the instruction issuer 3161.

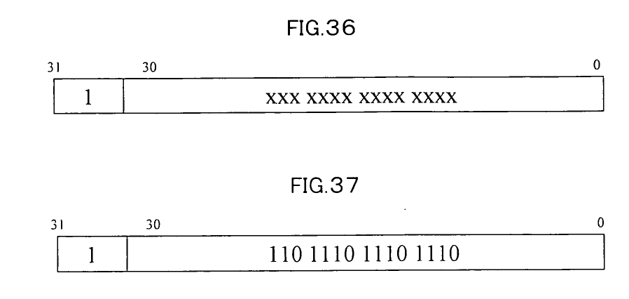

Hereinafter, the foregoing operation is described in detail. First, the instruction nullifier 3151 judges whether or not a part of instructions of the instruction packet (instruction string) fetched by the instruction fetcher 1001 have the particular bit pattern. The particular bit pattern mentioned here is a pattern in which a highest-order bit is “1” in a 16-bit instruction as shown in FIG. 36. It is not questioned if the other bits are “0” or “1”.

The instruction nullifier 3151 transmits a signal indicating that the relevant instruction is ineffective to the instruction issuer 3161 when it is judged that an arbitrary instruction has the particular bit pattern. The instruction issuer 3161 selects the instruction to be issued to the instruction decoder 2081 based on the signal indicating that the instruction supplied from the instruction nullifier 3151 is ineffective.

The instruction issuer 3151 nullifies the group of instructions comprising at least one of the instructions allocated at the address of the higher-order position than the ineffective instruction, and therefore, does not issues the group of instructions to the instruction decoders 3011-3013. When the instruction is not issued from the instruction issuer 3161, the instruction decoders 3011-3013 omit the decoding process and transmit the instruction signal corresponding to the NOP instruction to the multiplexer 1021.

The instruction decoders 3011-3013 output such a signal that any operator is not used as the instruction signal to the multiplexer 1021 when the debug instruction is decoded.

FIG. 37 shows a bit pattern of the debug instruction in the second preferred embodiment of the processor according to the present invention. In the debug instruction, the “0” constitutes the 0th bit, fourth bit, eighth bit and 12th bit, while the value “1” constitutes the other bits. Because a highest-order bit shows the value of “1” in this bit pattern, the group of instructions comprising at least one of the instructions allocated at the address of the higher-order position than the debug instruction in the instruction packet is entirely nullified, and therefore, not issued to the instruction decoders 3011-3013. Accordingly, the group of instructions allocated at the address of the higher-order position than the debug instructions is not executed.

As described, all of the debug instructions are decoded as the instructions that do not use the operator resource at all in the second preferred embodiment. Therefore, the shortage of the instruction execution resource such as the operator is not generated no matter where in the instruction packet the debug instruction is allocated. Then, the restrictions on the execution of the debug instruction no longer exist, and the debug instruction can be allocated at any arbitrary position in the instruction packet. Thereby, any arbitrary instruction can be replaced with the debug instruction when the break point for halting the program at any arbitrary position is set. Further, the execution of the instructions subsequent to the debug instruction in the instruction packet is cancelled. Therefore, when the program is halted at the break point due to the generation of the debug interruption, any instruction allocated at the address of the higher-order position than the break point is not executed. As a result, the relationship between the break point and the instruction execution is more intuitively grasped.

The number of the instructions capable of executing simultaneously is made to be three in the foregoing preferred embodiment in order to simplify the description. A similar constitution can be applied to a VLIW processor in which the number of the instructions capable of executing simultaneously is at least two, wherein it is obvious that a similar effect can be obtained.

### Preferred Embodiment of Debugging Method According to the Present Invention

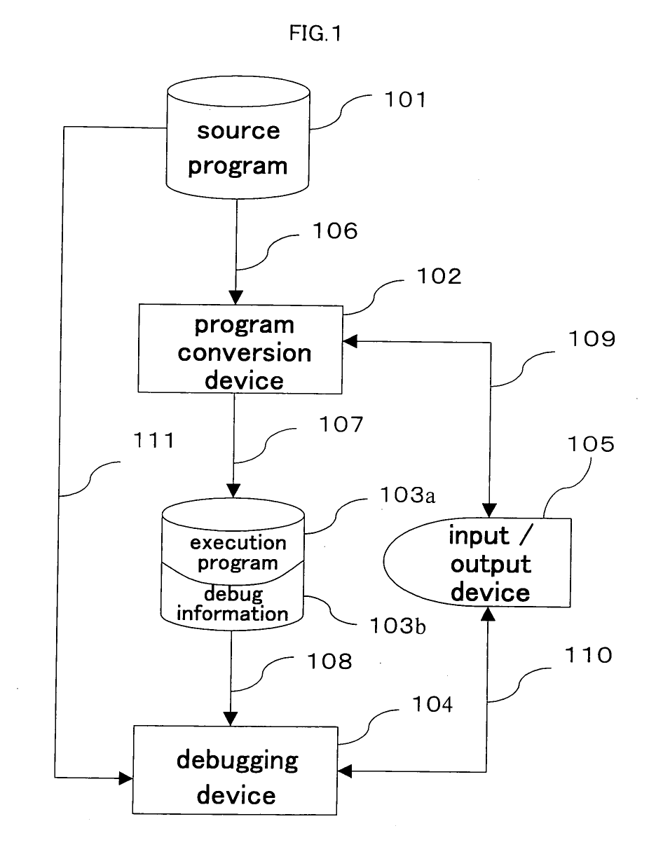

A preferred embodiment of a debugging method according to the present invention is described below referring to FIGS. 1-29. FIG. 1 shows a data flow in the case where a program converting device and a debugging device adopted in general are combined.

A source program 101 is converted into an execution program 103a by a program converting device 102 based on directions inputted by a user to an input/output device 105. At the time, a correlation between the source program 101 and the execution program 103a can be outputted as a debug information 103b.

A debugging device 104 refers to the source program 101 and the debug information 103b in the case where the execution program 103a is present based on the user's directions from the input/output device 105 to thereby control various debug operations such as the program execution, program halt, and reference on the state of the program.

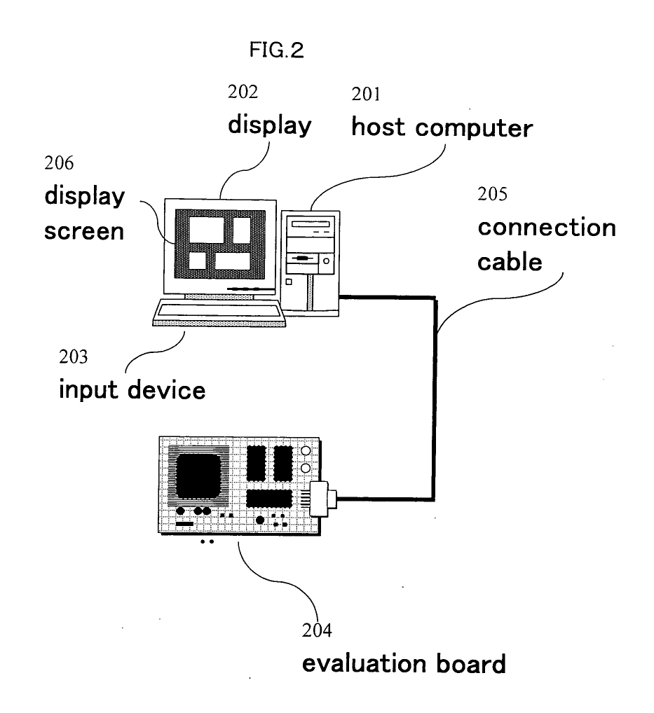

FIG. 2 shows an example of a more specific structure of the debugging device. 201 denotes a host computer for executing host-side software of the program converting device and the debugging device, and 204 denotes an evaluation board of the processor to be targeted, which are connected via a connection cable 205. When the processor to be targeted is simulated on the host computer, it becomes unnecessary to provide the evaluation board 204 and the connection cable 205. 201 denotes a display of an input device connected to the host computer. 203 denotes a keyboard and a mouse of the input device identically. 206 denotes a display screen for displaying the output of the debugging device.

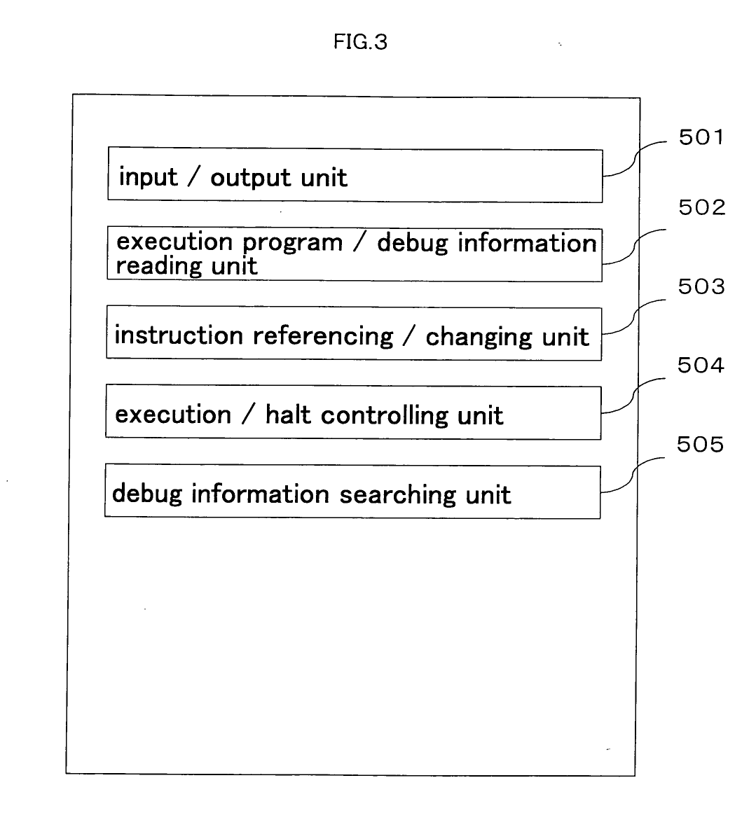

FIG. 3 shows the components used for control of the general debugging device. The debugging device comprises an input/output unit 501, an execution program/debug information reading unit 502, an instruction referring/changing unit 503, an execution/halt controlling unit 504, and a debug information searching unit 505.

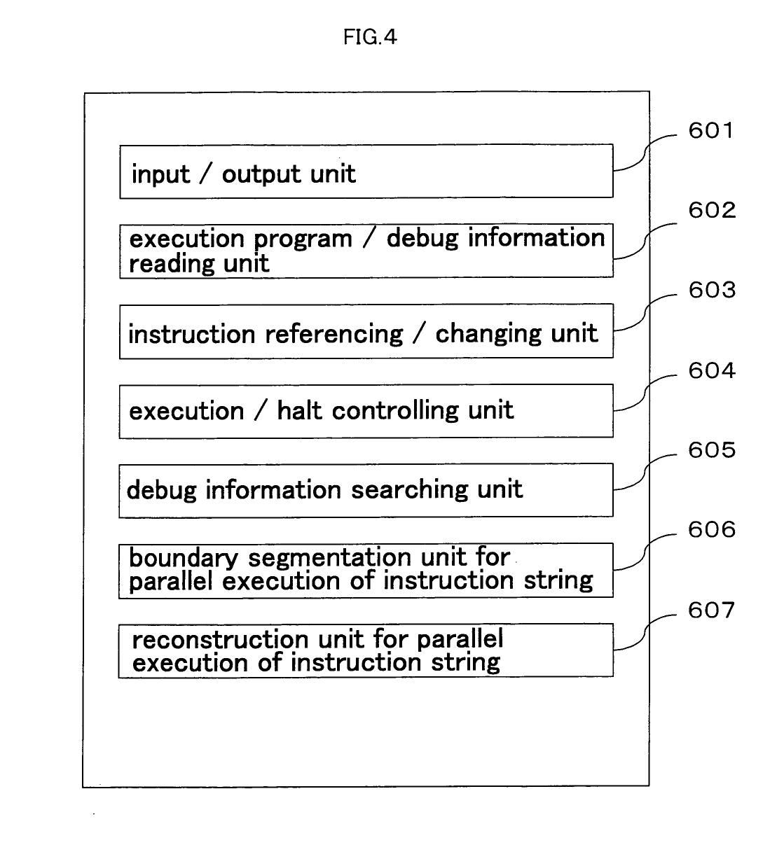

FIG. 4 shows the components used for control of a debugging device according to the preferred embodiment. Parts provided with reference numerals 601-605 is the same as those provided with reference numerals 501-505. A parallel execution instruction string boundary segmentation unit 606 is a device for additionally setting parallel boundaries there by decomposing parallel boundaries of a string of instructions capable of executing logically in parallel to the groups of instructions comprising at least one of the instructions that are further segmentalized. A parallel execution instruction string reconfiguration unit is a device for replacing the group of instructions in the string of instructions logically executable in parallel without changing the parallel boundaries in them.

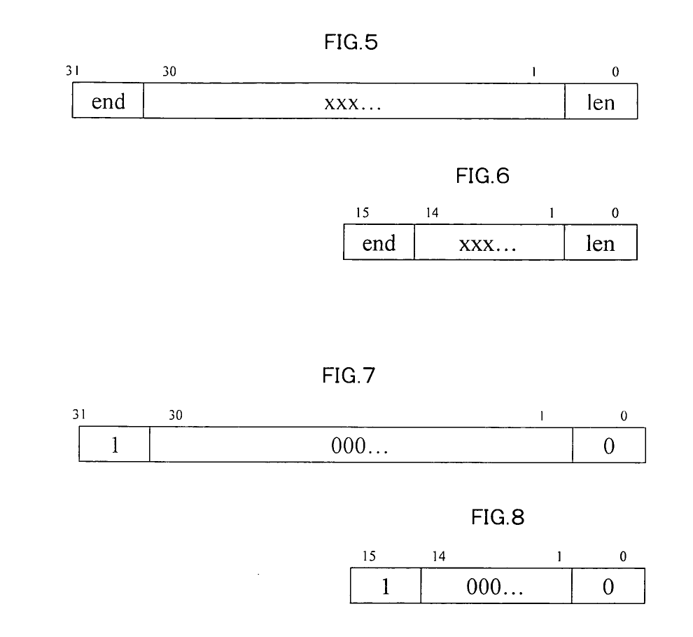

FIG. 5 shows a constituent example of a bit pattern in a 32-bit length instruction in a processor capable of logically executing in parallel in addition to the instructions having a variable length. A symbol “len” is a bit for discriminating the instruction length, and a symbol “end” is a bit of the parallel boundary. FIG. 6 shows an example of a bit pattern in a 16-bit length instruction in the processor capable of logically executing in parallel in addition to the instructions having a variable length. The meaning of the symbols “len” and “end” denote the same as in FIG. 5.

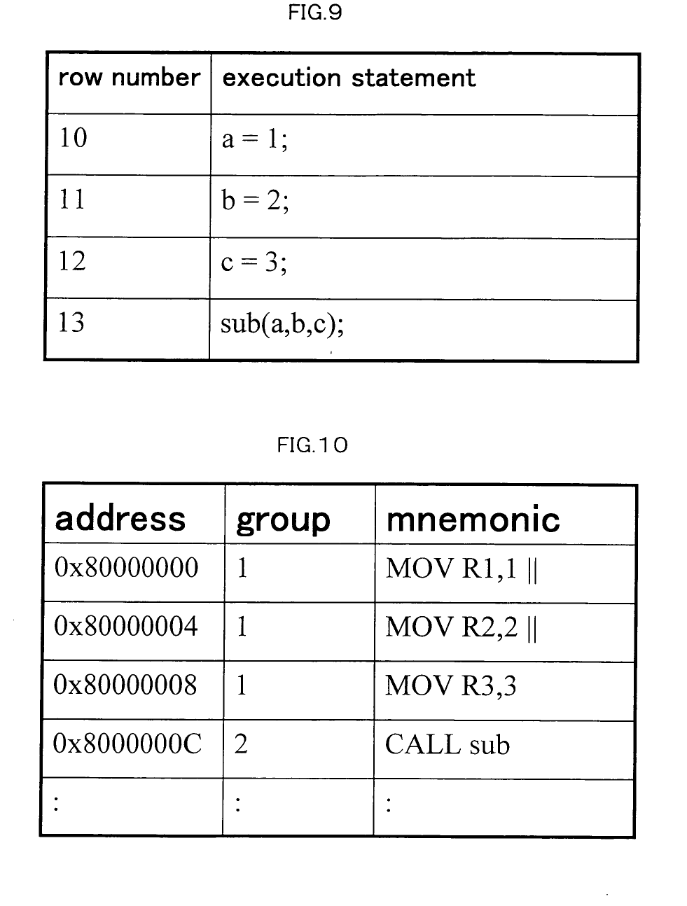

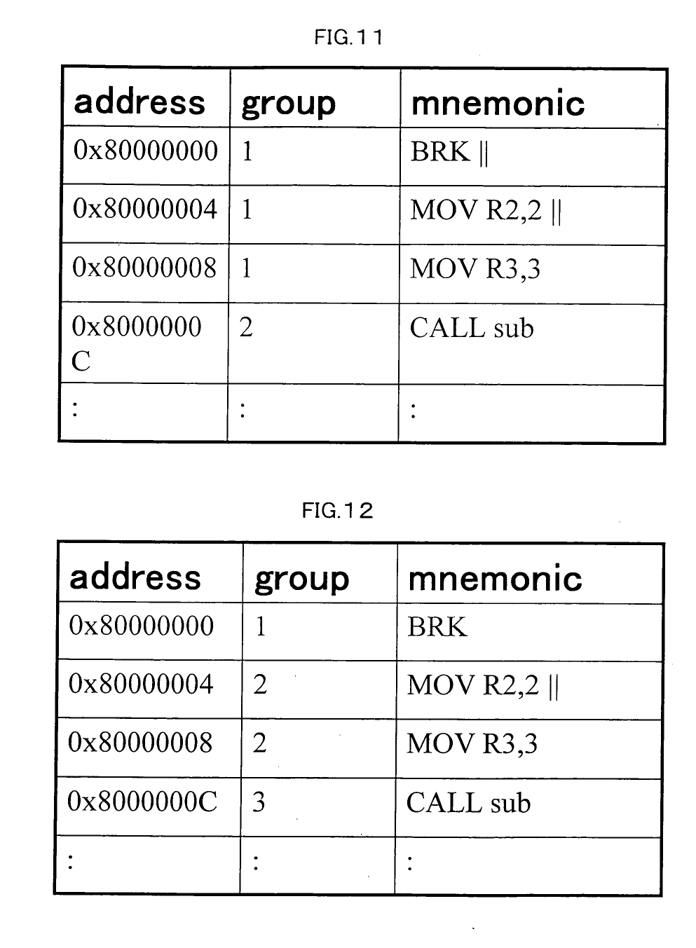

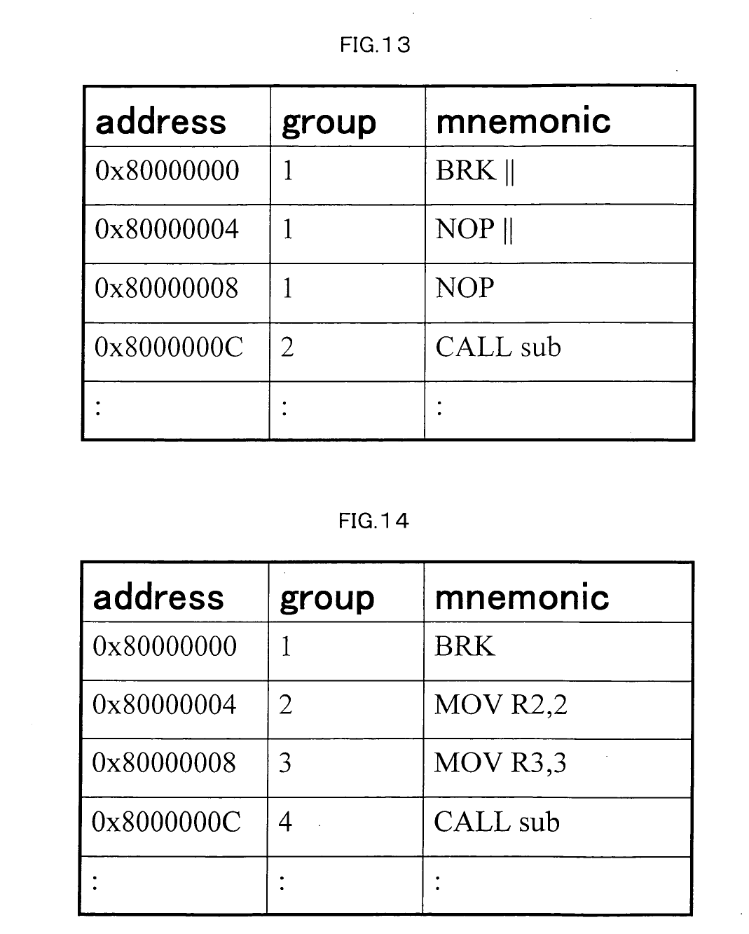

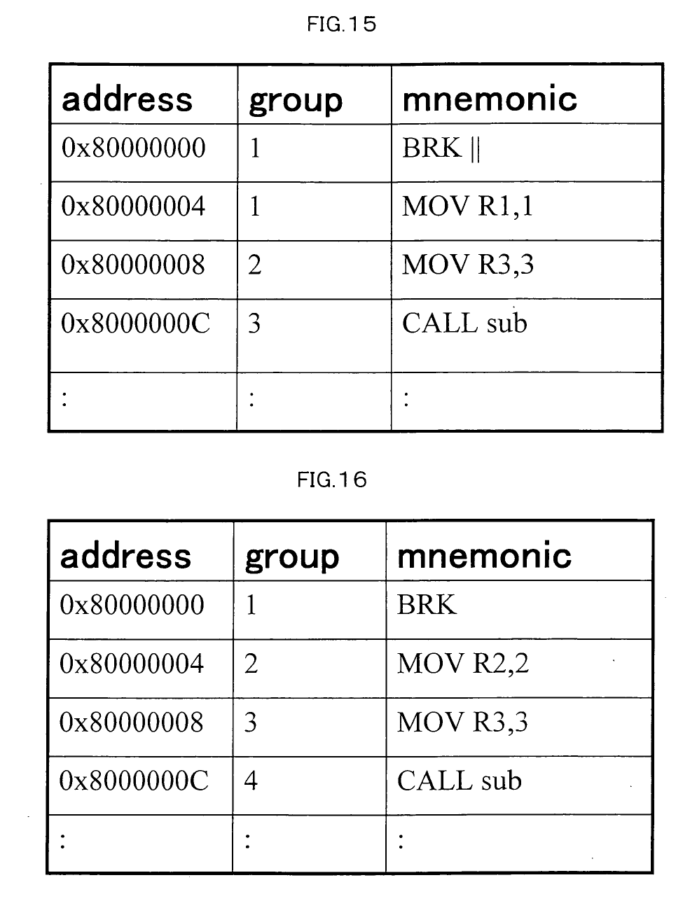

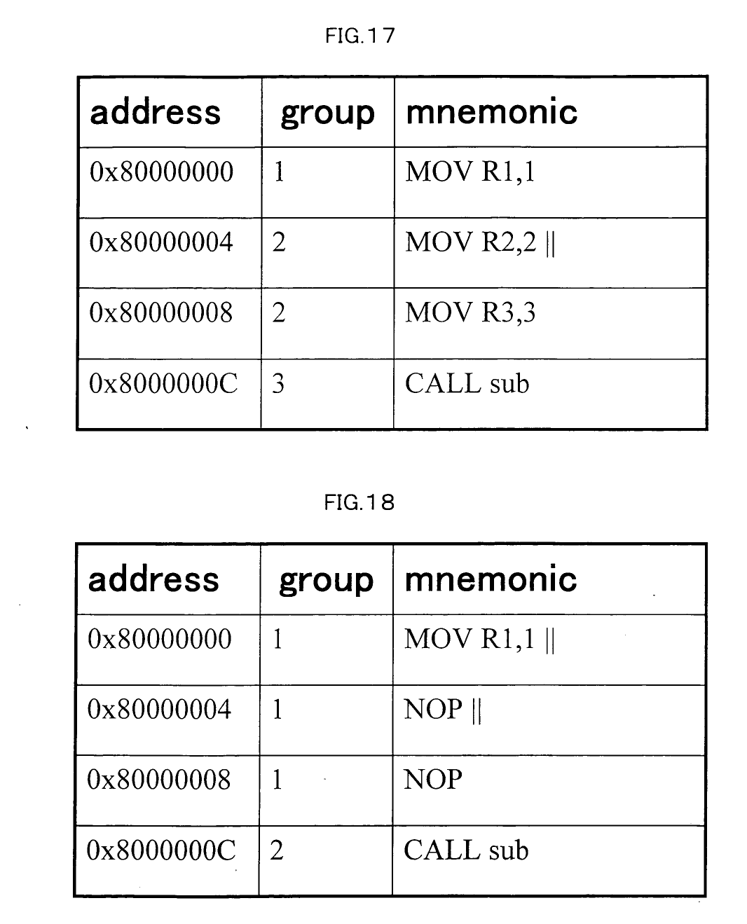

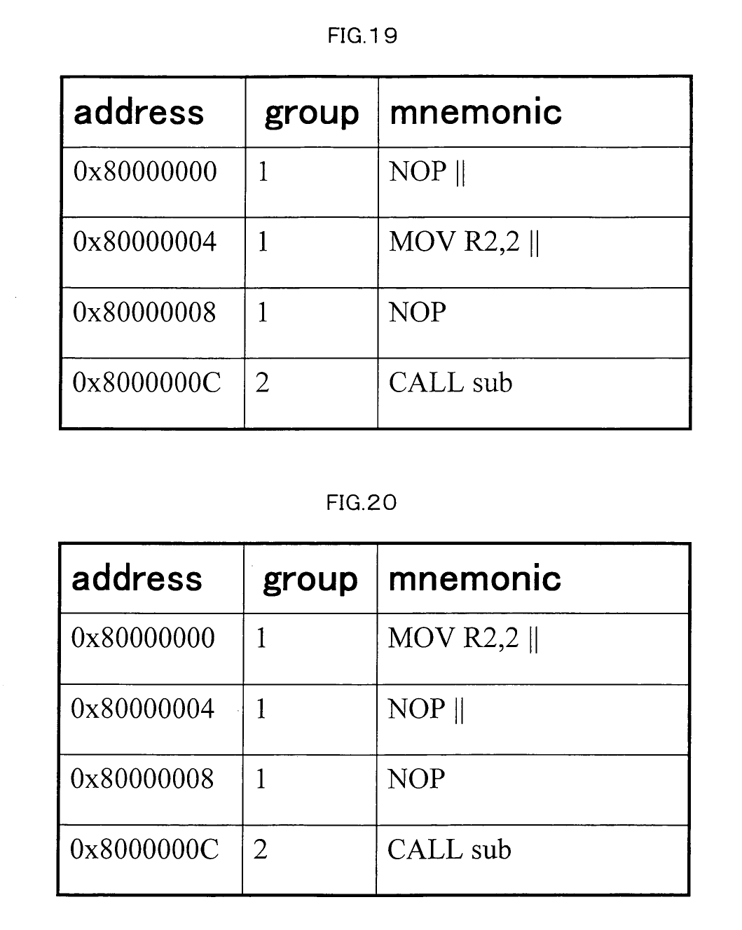

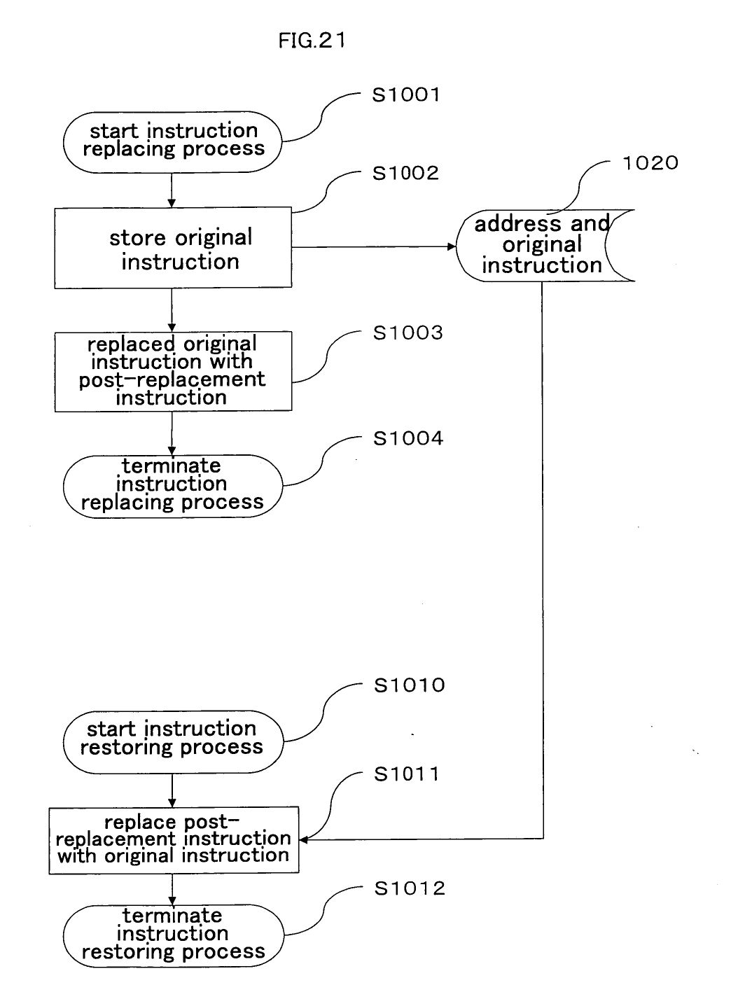

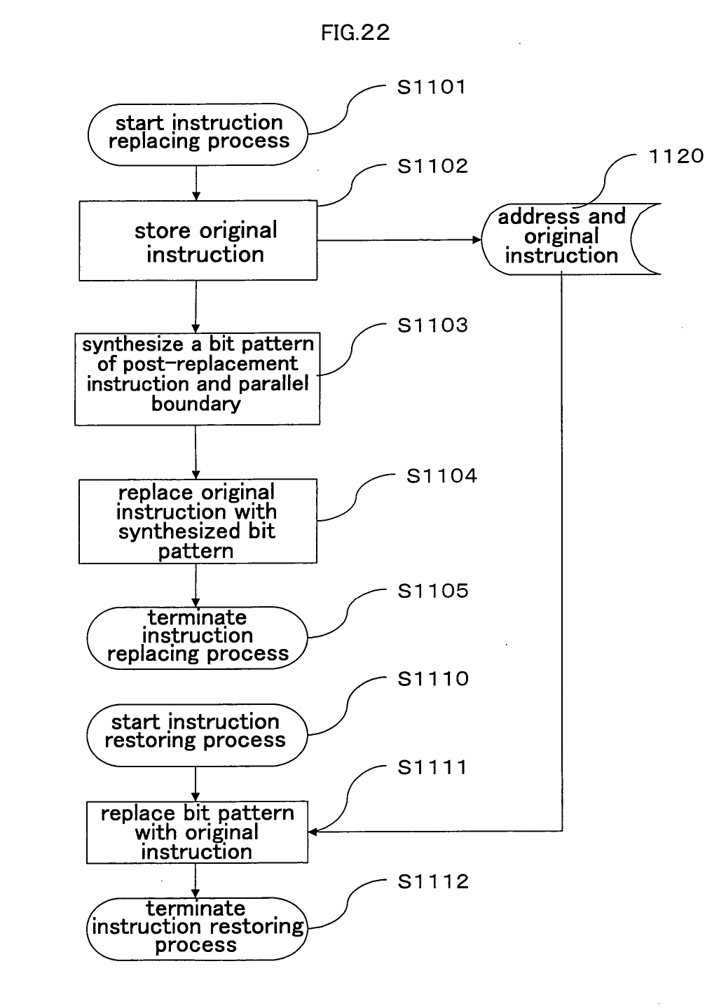

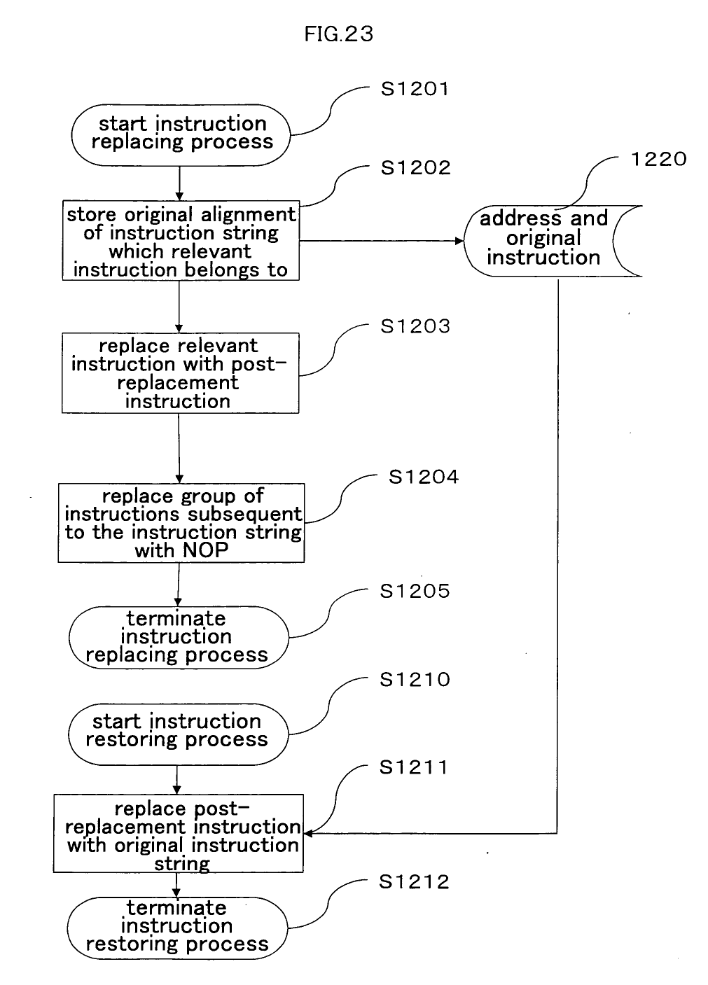

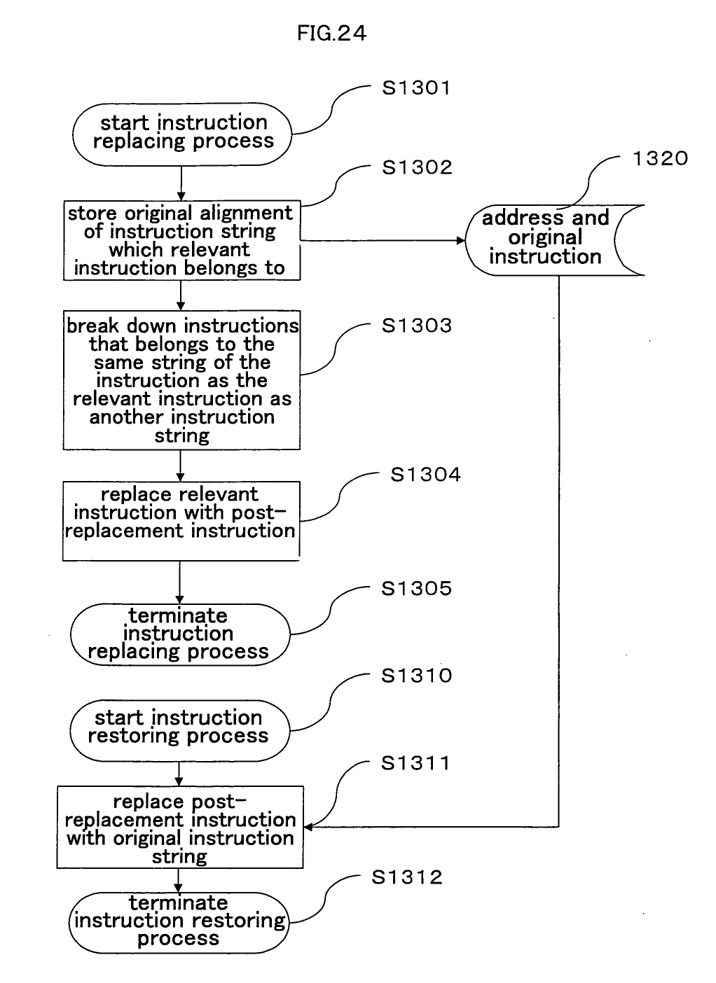

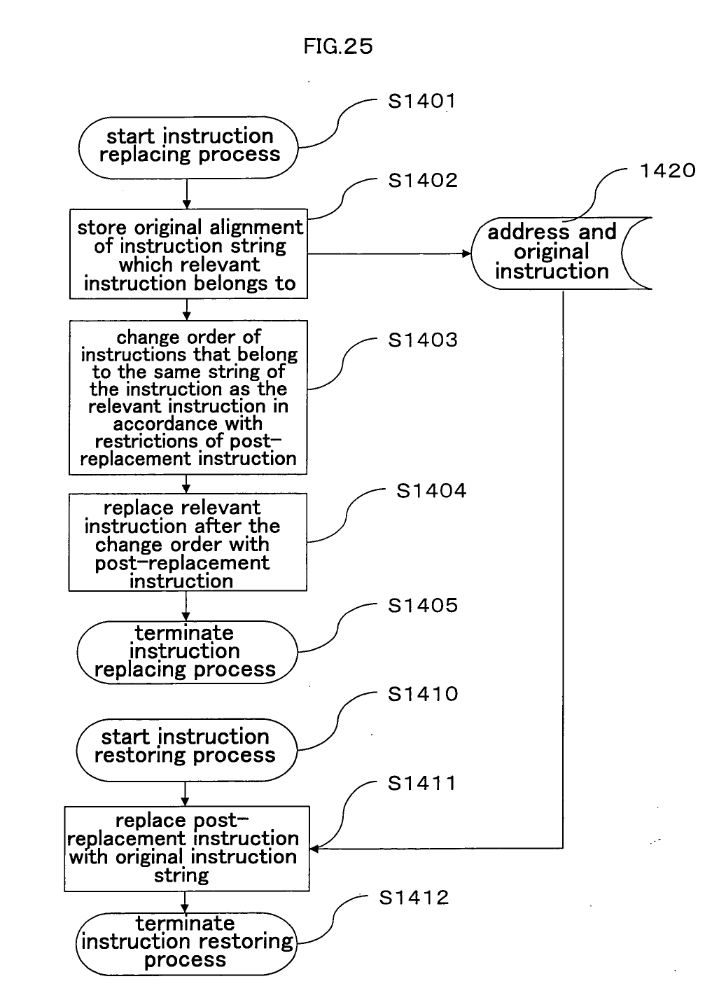

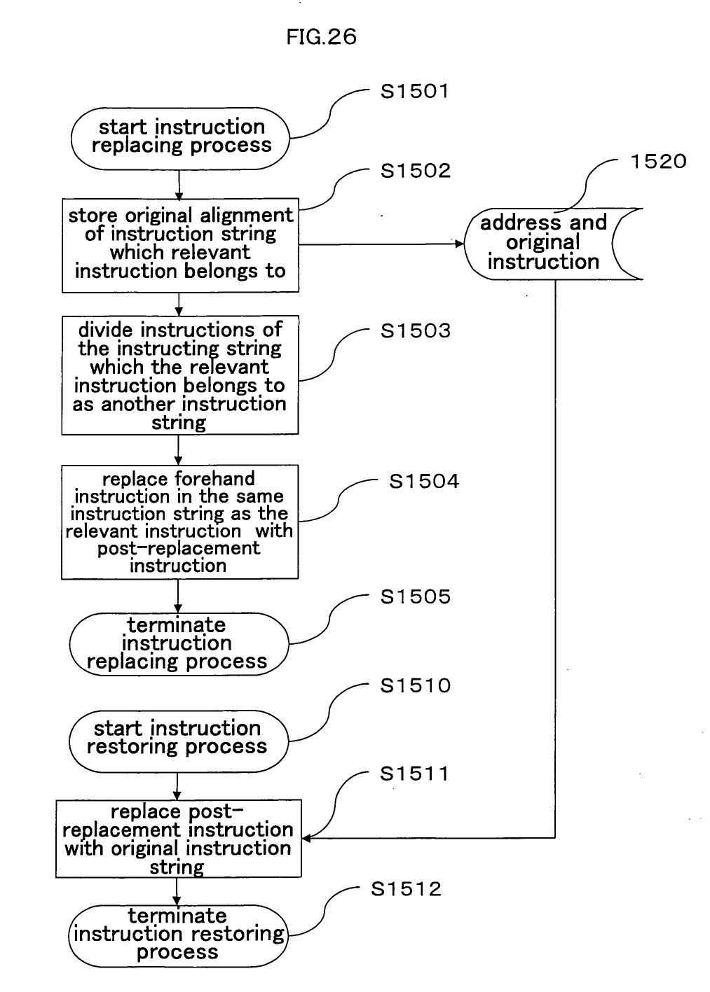

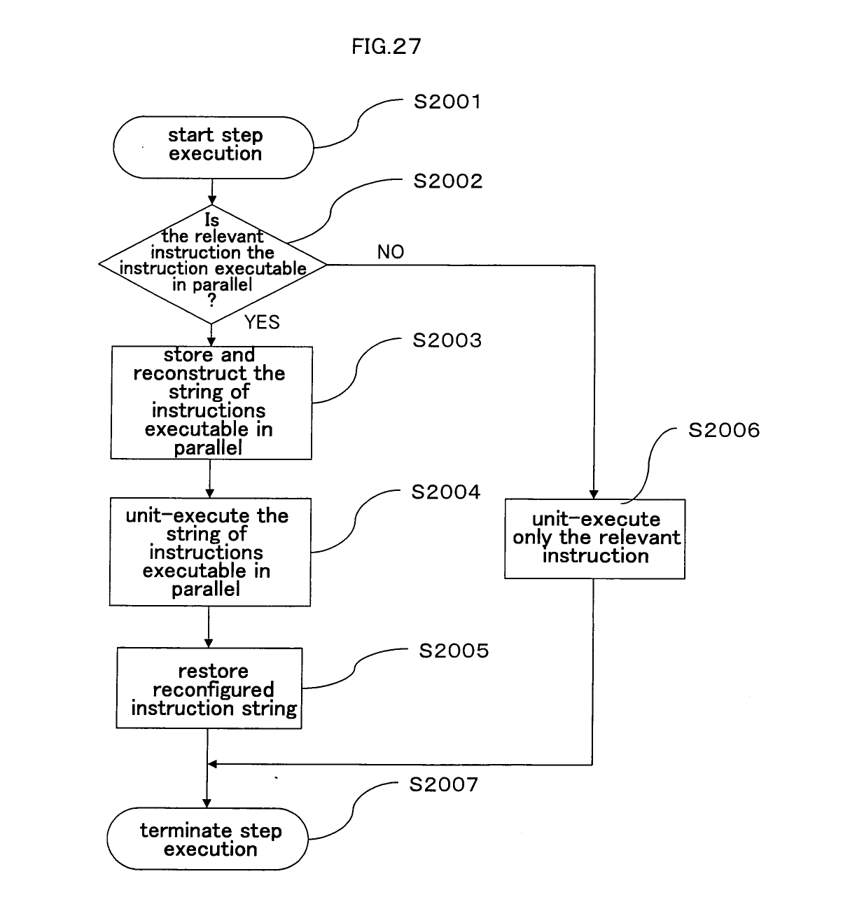

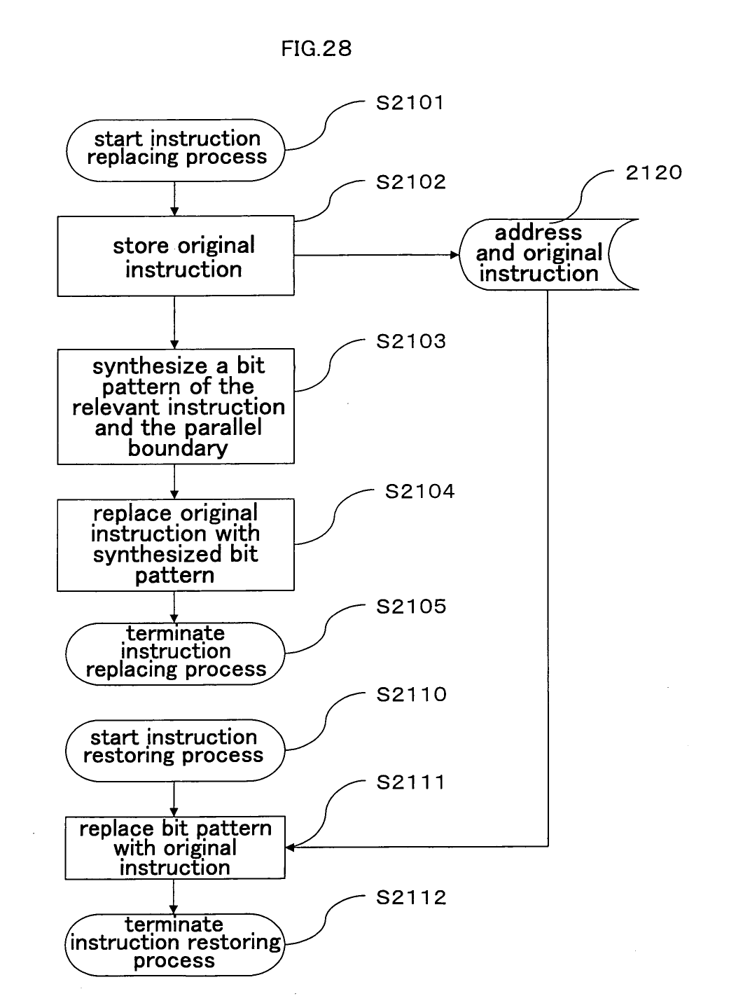

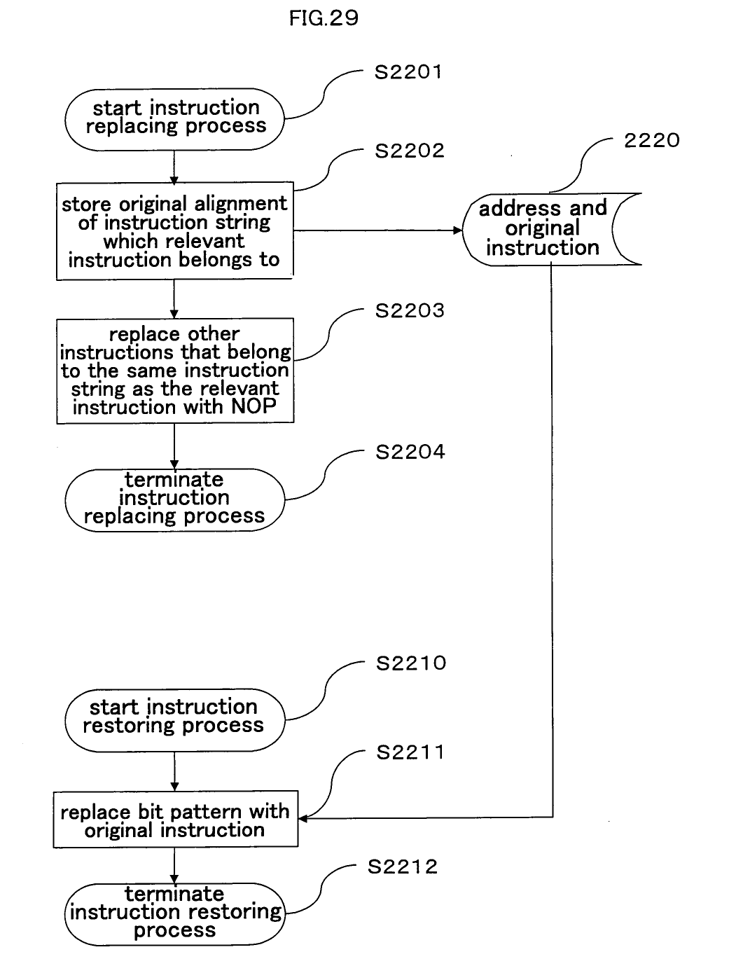

FIG. 7 shows a bit pattern for setting the parallel boundary in the bit pattern of the instruction shown in FIG. 5. FIG. 8 shows a bit pattern for setting the parallel boundary in the bit pattern of the instruction shown in FIG. 6. A logical addition of bit pattern shown in FIG. 7 or 8 and the bit pattern of the instruction for setting the parallel boundary becomes a bit pattern of the “instruction in which the parallel boundary is set”. FIG. 9 shows an example of a part of the source program 101. FIG. 10 shows an example of the execution program after the compilation of the source program shown in FIG. 9. FIG. 11 shows an example in which a forehand instruction of the execution program shown in FIG. 10 is replaced with the debug instruction according to the conventional technology. FIG. 12 shows an example in which the forehand instruction of the execution program shown in FIG. 10 is replaced with the debug instruction according to a process flow shown in FIG. 22. FIG. 13 shows an example in which the forehand instruction of the execution program shown in FIG. 10 is replaced with the debug instruction according to a process flow shown in FIG. 23. FIG. 14 shows an example in which the forehand instruction of the execution program shown in FIG. 10 is replaced with the debug instruction according to a process flow shown in FIG. 24. FIG. 15 shows an example in which a second instruction of the execution program shown in FIG. 10 is replaced with the debug instruction after an order of instructions is changed according to a process flow shown in FIG. 25. FIG. 16 shows an example in which the second instruction of the execution program shown in FIG. 10 is replaced with the debug instruction after the debug instruction is corrected according to a process flow shown in FIG. 26. FIG. 17 shows an example in which the forehand instruction of the execution program shown in FIG. 10 is replaced so as to realize step execution according to a process flow shown in FIG. 28. FIG. 18 shows an example in which the forehand instruction of the execution program shown in FIG. 10 is replaced so as to realize the step execution according to a process flow shown in FIG. 29. FIG. 19 shows an example in which the second instruction of the execution program shown in FIG. 10 is replaced so as to realize the step execution according to the process flow shown in FIG. 29. FIG. 20 shows an example in which the second instruction of the execution program shown in FIG. 10 is replaced by changing the order of the instructions in addition to the process flow shown in FIG. 29 so as to realize the step execution. FIG. 21 shows an example of a flow of the instruction replacing process according to the conventional technology. FIG. 22 shows an example of a flow of the instruction replacing process in the case where the parallel boundary can be changed and the post-replacement instruction can be executed in parallel. FIG. 23 shows an example of a flow of the instruction replacing process in the case where the parallel boundary cannot be changed. FIG. 24 shows an example of a flow of the instruction replacing process in the case where the parallel boundary can be changed but the post-replacement instruction cannot be executed in parallel. FIG. 25 shows an example of a flow of the instruction replacing process in the case where the order of the instructions capable of executing in parallel can be changed. FIG. 26 shows an example of a flow of the instruction replacing process in the case where software simulation is utilized. FIG. 27 shows an example of a flow of the step execution process. FIG. 28 shows an example of a flow in the case where the parallel boundary can be changed in S2003 shown in FIG. 27. FIG. 29 shows an example of a flow in the case where the parallel boundary cannot be changed in S2003 shown in FIG. 27.

Hereinafter, the present embodiment is described in detail referring to these drawings. In the case of debugging the program of the processor capable of executing in parallel using the debugging device, the user loads the execution program 103a into the debugging device 104 according to the flow described referring to FIG. 1. At the time, the debug information 103b, if present, is also loaded.

A description is given based on the assumption that a part of the source program 101 has the structure shown in FIG. 9. It is assumed that codes as shown in FIG. 10 are generated as a part of the execution program in consequence of the compilation of the source program 101 shown in FIG. 9. In the drawing, an address shows a position at which the instruction is stored, and a group shows a serial number for discriminating a cluster of the string of instructions that is logically executable in parallel for the convenience of the description. The group number itself is not included in an actual mechanical language code. In a mnemonic, the mechanical language code is replaced with a combination of a simplified English word and code so as to help the user understand the mechanical language code. An instruction “MOV R1, 1” indicates that the value “1” is transferred to an R1 register. An instruction “CALL sub” indicates that a function sub is called. A symbol “∥” at the end of mnemonic indicates that the relevant instruction can be logically executed in parallel with the instruction at the next address. The debug instruction for generating the debug interruption is a BRK instruction, and an instruction for advancing a program counter is an NOP instruction.

In the case where the user of the debugging device tries to set the break point in a row number 10 in FIG. 9, an address of the relevant mechanical code (0X80000000) can be converted based on the debug information 103b in the conventional technology. Replacing the relevant instruction with the debug instruction without changing the instruction boundary in the conventional technology, an instruction “MOV R1, 1 ∥” shown in FIG. 11 is replaced with an instruction “BRK ∥” shown in FIG. 12. The process flow according to the conventional technology is described below referring to a flow chart shown in FIG. 21.

An original instruction is memorized in a combination of an address and the original instruction as a data 1020 in Step S1002 as a precaution for a time to delete the break point after starting the instruction replacing process in Step S1001. The original instruction is replaced with the BRK instruction in the case of a post-replacement instruction, that is, the break point setting in Step S1003. The instruction replacing process is terminated in Step S1004. When the break point is deleted, an instruction restoring process starts in Step S1010. The memorized data (address and original instruction) 1020 is read and replaced with the original instruction in Step S1011. Then, the instruction restoring process is terminated in Step S1012.

In the present invention, such a disadvantage in the conventional process (parallel boundary cannot be set) is solved by means of any of methods shown in FIGS. 22, 23 and 24.

In the case where the processor has such an architecture that the parallel boundary can be set at any arbitrary instruction, the method shown in FIG. 22 can be adopted. The instruction replacing process starts in Step S1101, and the original instruction and the address thereof are memorized as a data 1120 in Step S1102. It is the same as the conventional technology until here. Then, in Step S1103, the post-replacement instruction (BRK instruction in the case where the break point is set) and the bit pattern at the parallel boundary are synthesized. In the case where the break point is set, the bit pattern is synthesized as the parallel boundary because it is desirable to be delimited by the relevant instruction. Referring to the architecture having such instruction lengths of the two types as 32-bit length and 16-bit length as an example, first, the instruction length is judged by the “len” bit showing the instruction length. In this example, as “x x x . . . ” is the bit pattern showing the instruction itself, this part becomes the pattern of the BRK instruction. The “end” bit shows the parallel boundary, and it is regarded that the “end” bit is not the boundary when the value shown therein is “0”, while being the boundary when the value shown therein is “1”. The synthesizing process in this step is realized by obtaining the logical addition of the bit pattern for setting the parallel boundary shown in FIG. 7 or 8 in accordance with the read pattern of the BRK instruction and instruction length. Finally, in Step S1104, the instruction is replaced with the bit pattern synthesized in the Step S1103, and the instruction replacing process is terminated in Step S1105.

In the case of deleting the break point, Steps S110-S1112 are executed in a manner similar to the conventional steps S1010-S1012.

In the case of setting the break point in the row number 10 corresponding to the source program shown in FIG. 9 according to the process flow shown in FIG. 22, the setting becomes a state replaced in the debugging device as shown in FIG. 12. In the case where the processor has such an architecture that the parallel boundary can be set per one or three instructions but cannot be set per two instructions, the method shown in FIG. 24 is adopted.

The method shown in FIG. 24 is described below. The instruction replacing process starts in Step S1301, and the relevant instruction at which the break point is desirable to be set and an original alignment of the string of instructions logically executable in parallel, are memorized as a data 1320 in Step S1302 in a combination of the instructions of the string and addresses of the instructions respectively. In Step S1303, the other instructions of the string of instructions to which the relevant instruction belongs are broken down as another string of instructions in the range of restrictions of the processor. The break-down treatment is carried out by setting the parallel boundary as with the previous description of FIG. 22. In Step S1304, the relevant instruction is replaced with the post-replacement instruction, that is the BRK instruction, and the instruction replacing process is terminated in Step S1305. In the case of deleting the break point, the operations by Steps S1310-S1312 are executed in a manner similar to the conventional steps S1010-S1012. However, the Steps S1310-1312 are different from the Steps S1010-S1012 in a point that not the single instruction but the same string of instructions is restored in the Step S1311.

In the case of setting the break point in the row number 10 corresponding to the source program shown in FIG. 9 according to the process flow shown in FIG. 24, the setting goes into a state as replaced inside the debugging device as shown in FIG. 14. If it is possible to break down the position at which the break point is set into the parallel boundaries within the restrictions of the processor, the process can be executed according to the process flow shown in FIG. 24.

In the case where the position at which the break point is set cannot be broken down into the parallel boundaries even in the foregoing method, the method according to the present invention shown in FIG. 23 is adopted. The method shown in FIG. 23 is described below. The instruction replacing process starts in Step S1201. Step S1202 subsequent thereto is the same as the Step S1302 described earlier. In next Step S1203, the instruction at the position where the break point is desirable to be set is replaced with the post-replacement instruction, namely, the BRK instruction. In Step S1204, a group of instructions comprising at least one of the instructions subsequent in the string of instructions to which the relevant instruction belongs is replaced with the NOP instruction which merely advances the program counter. When the foregoing steps are completed, the instruction replacing process is terminated in Step S1205.

In the case of deleting the break point, Steps S1210-1212 similar to the Steps S1310-S1312 are executed. In the case of setting the break point in the row number 10 corresponding to the source program shown in FIG. 9 according to the process flow shown in FIG. 23, the setting goes into a state as replaced inside the debugging device as shown in FIG. 13. In this case, there is a possibility that the program actually halts after the NOP instruction at the address of “0x80000008” is executed. However, in the debugging device, such a correction for the purpose that the halt occurred at the address “0x80000000” is made by means of the address in the information of the data 1320.

Next, a description is given based on an example in which only one execution statement (not the instruction but statement) is step-executed from the position of the row number 10 in the source program shown in FIG. 9 in the debugging device. The mechanical language codes corresponding to the relevant source program are hypothetically generated as shown in FIG. 10.

In the case where the processor is requested to execute the step execution, as the mechanical language code corresponding to the row number 10 and the mechanical language code corresponding to row numbers 11 and 12 can be logically executed in parallel, there is a possibility that both codes are simultaneously executed. A method according to the present invention in which the foregoing disadvantage is improved, is shown in FIG. 27.

FIG. 27 shows a basic control flow of the step execution corresponding to the parallel execution according to the present invention. The step execution process starts in Step S2001. In Step S2002, it is judged whether or not the instruction to be desirable to be step-executed is the instruction executed in parallel. In the case of the instruction formats shown in FIGS. 5 and 6, it can be determined that the relevant instruction is the instruction executed in parallel when the end bit shows the value “0”.

When it is judged that the relevant instruction is not the instruction executed in parallel in Step S2002, only the relevant instruction is unit-executed in Step S2006, and the step execution process is terminated in Step S2007. This process is similar to that of the conventional processor incapable of the parallel execution.

When it is judged that the relevant instruction is the instruction executed in parallel in the Step S2002, the instruction (string of the instruction executed in parallel) is reconstructed so that it can be unit-executed. At the time, the original instruction is stored. Details of the storage will be described later referring to FIGS. 28 and 29.

The reconstructed string of the instruction executed in parallel is unit-executed in Step S2004. Further, the instruction string reconstructed in the Step S2003 is restored to the original instruction string in Step S2005. The original instruction string is stored in the Step S2003 in the same manner. When the foregoing steps are completed, the step execution process is terminated in Step S2007.

The process in S2003 is described in detail. The instruction replacing process starts in Step S2101. Then, in Step S2102, the address of the position at which the instruction is desirable to be executed and the original instruction are stored in combination as a data 2120. Next, the relevant instruction and the bit pattern of the parallel boundary are synthesized in Step S2103. The synthesizing process of the bit pattern of the parallel boundary is the same as in the Step S1103 in the process flow shown in FIG. 22. Next, the original instruction is replaced with the synthesized bit pattern in Step S2104, and the instruction replacing process is terminated in Step S2105.

The instruction restoring process starts when a series of the instruction replacing process is halted (S2105) after the foregoing steps are executed (Step 2110). When the instruction restoring process starts, the replaced instruction is replaced with the address and the original instruction stored in the data 2120, and the instruction restoring process is terminated in Step S2112.

According to the steps described so far, the replacement shown in FIG. 17 is executed only during the step execution, and only the instruction at the address of “0x80000000” can be executed as a single group. Thereby, in the row number 10, for example, only the instruction corresponding to one execution statement can be executed separately from the other row numbers.

In the case where the parallel boundary cannot be changed due to the restrictions of the processor, the method according to the present invention shown in FIG. 29 is adopted. The instruction replacing process starts in Step S2201. Next, in Step S2202, the each address of the instructions in the same string of instructions as the relevant instruction to be desirable to be step-executed and the original instructions are stored as a data 2220. Next, in Step S2203, the instructions other than the relevant instruction, that belong to the same string of instructions with the relevant instruction, are replaced with the NOP instruction. After the foregoing steps are executed, the instruction replacing process is terminated in Step S2204.

When a series of the instruction replacing process is halted after the foregoing steps are executed (Step S2204), the instruction restoring process starts (Step S2210). When the instruction restoring process starts, the replaced instruction is replaced with the address and the original instruction stored in the data 2220 in Step S2211, and the instruction restoring process is terminated in Step S2212.

According to the steps described so far, the replacement is executed only during the step execution as shown in FIG. 18, and the step execution is executed from the address “0x80000000”. In this case, there is a possibility that the actual halt possibly occurs after the NOP instruction at the address of “0x80000008” is executed. However, in the debugging device, such a correction that the halt occurred at the address “0x80000004”, that is the address advanced by one instruction, is made by means of the address of the data 2220. In the case of executing the step in the same way, the instructions at the address “0x80000000” and the address “0x80000008” are replaced with the NOP instruction so that an effect similar to the effect obtained when only the instruction at the address “0x80000004” is executed can be obtained as shown in FIG. 19.

In the case where the processor has such restrictions that the NOP instruction can be allocated only at the end of the instruction string, the order of the instructions is changed so that any instruction other than the NOP instruction is placed at the top of the instruction string and the NOP instruction follows the instruction as shown in FIG. 20. As a result, contravention of the restrictions can be avoided.

In the case where the processor has such restrictions that a description point of the debug instruction is necessary to be at the end of the instruction string, the position of the debug instruction is moved to the end of the instruction string in accordance with the restrictions, and a group of instructions comprising at least one of the instructions between the position where the debug instruction is originally desirable to be set and the moved position is replaced respectively with the NOP instruction. This process is the same as that of FIG. 29. Then, the debugging device makes such a correction that the halt position is the position where the break point is originally desirable to be set. Thereby, contravention of the restrictions can be avoided.

In the case where the processor has such restrictions that a description point of the debug instruction is necessary to be at the top of the group of the instructions, the debug instruction is inserted at the top of the instruction string in accordance with the restrictions. Further, the order of the instructions up to the point where the debug instruction is originally desirable to be set is changed so that the instructions are moved down by the ones due to the inserted debug instruction. As a result, the restrictions can be avoided. For example, in the case where the break point is desirable to be set at the second instruction in FIG. 10, as shown in FIG. 25, the instruction replacing process starts in Step S1401, and the original instruction of the instruction string to which the relevant instruction belongs are memorized in combination of the address thereof and the original instruction as a data 1420. Further, in Step S1403, the relevant instruction is moved to the top of the instruction string in accordance with post-replacement instruction allocation restrictions (in the relevant restrictions, any instruction of the instruction string to which the relevant instruction belongs can be set only at the top of the instruction string). Then, groups of instructions comprising at least one of the instructions between the position of the instruction originally at the top of the instruction string and the original position of the relevant instruction are sequentially moved down respectively. The relevant instruction after the order change is no longer bound by the post-replacement instruction allocation restrictions. Therefore, the relevant instruction changed in the order is replaced with the post-replacement instruction in Step S1404. When the steps described so far are completed, the instruction replacing process is terminated in Step S1405. As a result, the instruction string is replaced with the instruction string shown in FIG. 15.

In the case where the processor has such restrictions that a description point of the debug instruction is necessary to be at the top of the instruction string, the position of the debug instruction is moved to the top of the instruction string in accordance with the restrictions, and a group of instructions comprising at least one of the instructions between the top position and the position at which the break point is originally desirable to be set is simulated with software. As a result, contravention of the restrictions can be avoided. In the case where the break point is desirable to be set at the second instruction in FIG. 10, for example, the instruction replacing process starts in Step S1501 as shown in the process of FIG. 16. Next, in Step S1502, each of the instructions that belong to the same instruction string as the relevant instruction is memorized as a data 1520 in combination of the addresses and the original instructions. Next, the relevant instruction and each of the instructions that belong to the same instruction string with the relevant instruction are broken down as another instruction string in Step S1503. This process is similar to the process of the Step S1303 in FIG. 24. Then, the relevant instruction and the instruction at the top of the same instruction string with the relevant instruction is replaced with the post-replacement instruction in accordance with the restrictions in Step S1504. When the foregoing steps are completed, the instruction replacing process is terminated in Step S1505. As a result of the foregoing steps, the state shown in FIG. 15 is obtained. Then, the execution of the program starts, and the instruction restoring process starts in Step S1510 in the case where the break point is detected in the BRK instruction. After the instruction restoring process starts, the original instruction string is restored based on the addresses memorized as the data 1520 in Step S1511. Then, the instruction restoring process is terminated in Step S1512. Thereby, the instructions between the position at which the break point is detected and the position at which the break point is desirable to be originally set are software-simulated one by one. In the case of the instruction “MOV R1, 1”, the value “1” is set in the R1 register for the software simulation. The process flow from the Step S1501 is executed again when the position at which the break point is desirable to be originally set is reached so that the state where instruction is replaced is regained. The position at which the break point is detected is replaced with the position at which the break point is originally desirable to be set, and the detection of the break point by the debugging device is terminated.

In the case of the processor having such restrictions that the parallel boundary cannot be changed and there is no NOP instruction, neither of the methods of FIGS. 28 and 29 described earlier can be adopted. In the case where the forehand execution statement shown in FIG. 9 is desirable to be step-executed, the instruction string corresponding to the execution statement is searched and obtained from the debug information 103b. In the case where the mechanical language codes as shown in FIG. 10 are generated, only the instruction at the address of “0x80000000” is extracted at the time. In the example shown in FIG. 10, as the relevant instruction is “MOV R1, 1”, the value “1” is set in the R1 register in the debugging device for the software simulation. Thereby, an effect similar to the one obtained when only the relevant instruction is step-executed by the processor can be apparently obtained.

Though the preferred embodiments of this invention are described in detail, it will be understood that various modifications may be made therein, and it is intended to cover in the appended claims all such modifications as fall within the true spirit and scope of this invention.

What is claimed is:

1. A processor capable of executing instructions in parallel, and executing a string of instructions comprising a plurality of instructions allocated at continuous addresses as an execution unit, comprising:
an instruction analyzer comprising debug instruction detectors for detecting a debug instruction which generates debug interruption wherein the instruction detectors of the same number as the instructions that can be executed in parallel by the processor are provided;
an instruction executor for executing a group of instructions comprising at least one of the instructions, that is included in the same string of instructions as the detected debug instruction and allocated at an address of a lower-order position than the detected debug instruction when the debug instruction is detected by the instruction analyzer; and
an instruction canceller for canceling execution of a group of instructions comprising at least one of the instructions, that is included in the same string of instructions as the detected debug instruction and allocated at an address of a higher-order position than the detected debug instruction when the debug instruction is detected by the instruction analyzer.

2. A processor capable of executing instructions in parallel, and executing a string of instructions comprising a plurality of instructions allocated at continuous addresses as an execution unit, comprising:
an instruction analyzer comprising debug instruction detectors for detecting a debug instruction which generates debug interruption wherein the instruction detectors of the same number as the instructions that can be executed in parallel by the processor are provided;
an instruction fetcher for fetching the string of instructions from outside;
an instruction part judger for judging whether or not a part of the respective string of instructions fetched by the instruction fetcher consists with a particular bit pattern;
an instruction nullifier for nullifying a group of instructions comprising at least one of the instructions allocated at an address of a higher-order position than the instruction consistent with the particular bit pattern when the instruction part judger judges that the string of instructions includes the instruction consistent with the particular bit pattern;
an instruction issuer for issuing the particular bit pattern accordance instruction and a group of instructions comprising at least one of the instructions at an address of a lower-order position than the relevant particular bit pattern accordance instruction to the instruction analyzer when the instruction part judger judges that the plurality of instructions includes the instruction consistent with the particular bit pattern; and
an instruction decoder for decoding an arbitrary instruction selected from the particular bit pattern accordance instructions as the debug instruction.

3. An instruction execution control method comprising:
a step of being provided in a program operated by a processor capable of executing instructions in parallel and changing an instruction boundary in a string of instructions comprising a plurality of instructions logically executable in parallel; and
a step of setting a break point at any of the instructions constituting the string of instructions.

4. The instruction execution control method according to claim 3, further comprising a step of replacing a group of instructions comprising at least one of the instructions subsequent to the arbitrary instruction at which the break point is set with a group of instructions comprising at least one of the instructions not affecting an operation result to be guaranteed when the group of instructions are executed.

5. An instruction execution control method comprising:
a step of being provided in a program operated by a processor capable of executing instructions in parallel and changing an instruction boundary in a string of instructions comprising a plurality of instructions logically executable in parallel; and
a step of selectively executing at least one of an arbitrary instructions in the string of instructions.

6. The instruction execution control method according to claim 5, wherein
the processor is generated from a source program, and
a correlation between an execution statement of the source program and the string of instructions is extracted from a debug information in which the execution statement of the source program and an address position of the instruction are correlated to each other, and thereafter the arbitrary instruction is selected based on the extracted correlation.

7. The instruction execution control method according to claim 5, further comprising a step of replacing the instruction other than the arbitrary instruction with the instruction not affecting an operation result to be guaranteed when the instruction is executed.

8. An instruction execution control method comprising:
a step of changing an order of instructions within such a range that does not affect an operation result to be guaranteed in a string of instructions that is provided in a program operated by a processor capable of executing instructions in parallel and consists of a plurality of instructions logically executable in parallel; and
a step of setting a break point at any of the instructions constituting the string of instructions.

9. An instruction execution control method comprising:
a step of changing an order of instructions within such a range that does not affect an operation result to be guaranteed in a string of instructions that is provided in a program operated by a processor capable of executing instructions in parallel and consists of a plurality of instructions logically executable in parallel; and
a step of selectively executing an arbitrary instruction in the string of instructions.

10. The instruction execution control method according to claim 9, wherein
the processor is generated from a source program, and
a correlation between an execution statement of the source program and the string of instructions is extracted from a debug information in which the execution statement of the source program and an address position of the instruction are correlated to each other, and thereafter the arbitrary instruction is selected based on the extracted correlation.

11. An instruction execution control method comprising:
a step of setting a break point at an arbitrary instruction in a string of instructions that is provided in a program operated by a processor capable of executing instructions in parallel and consists of a plurality of instructions logically executable in parallel;
a step of correcting a position at which the break point is set in accordance with restrictions of the processor;
a step of detecting whether or not the execution of the instruction is halted at the corrected break point; and
a step of software-simulating a group of instructions comprising at least one of the instructions between the corrected break point and the break point before the correction when it is detected that the execution of the instruction is halted at the corrected break point.

12. An instruction execution control method comprising:
a step of extracting a group of instructions comprising at least one of the arbitrary instructions from a string of instructions that is provided in a program operated by a processor capable of executing instructions in parallel and consists of a plurality of instructions logically executable in parallel; and
a step of software-simulating the extracted group of arbitrary instructions.

13. The instruction execution control method according to claim 12, wherein
the processor is generated from a source program, and
a correlation between an execution statement of the source program and the string of instructions is extracted from a debug information in which the execution statement of the source program and an address position of the instruction are correlated to each other, and thereafter the arbitrary instruction is selected based on the extracted correlation.

14. A debugging device comprising:
a changing unit for changing an instruction boundary in a string of instructions that is provided in a program operated by a processor capable of executing instructions in parallel and consists a plurality of instructions logically executable in parallel; and
a setting unit for setting a break point at any of the instructions constituting the string of instructions.

15. The debugging device according to claim 14, further comprising a replacing unit for replacing a group of instructions comprising at least one of the instructions subsequent to the arbitrary instruction at which the break point is set with a group of instructions comprising at least one of the instructions not affecting an operation result to be guaranteed when the group of instructions are executed.

16. A debugging device comprising:
a changing unit for changing an instruction boundary in a string of instructions that is provided in a program operated by a processor capable of executing instructions in parallel and consists a plurality of instructions logically executable in parallel; and
an execution unit for selectively executing at least one of the arbitrary instructions in the string of instructions.

17. The debugging device according to claim 16, wherein
the processor is generated from a source program, and
a correlation between an execution statement of the source program and the string of instructions is extracted from a debug information in which the execution statement of the source program and an address position of the instruction are correlated to each other, and thereafter the arbitrary instruction is selected based on the extracted correlation.

18. The debugging device according to claim 16, further comprising a replacing unit for replacing the instruction other than the arbitrary instruction with the instruction not affecting an operation result to be guaranteed when the instruction is executed.

19. A debugging device comprising:
a changing unit for changing an order of instructions within such a range that does not affect an operation result to be guaranteed in a string of instructions that is provided in a program operated by a processor capable of executing instructions in parallel and consists of a plurality of instructions logically executable in parallel; and
a setting unit for setting a break point at any of the instructions constituting the string of instructions.

20. A debugging device comprising:
a changing unit for changing an order of instructions within such a range that does not affect an operation result to be guaranteed in a string of instructions that is provided in a program operated by a processor capable of executing instructions in parallel and consists of a plurality of instructions logically executable in parallel; and
an execution unit for selectively executing an arbitrary instruction in the string of instructions.

21. The debugging device according to claim 20, wherein
the processor is generated from a source program, and
the execution unit extracts a correlation between an execution statement of the source program and the string of instructions from a debug information in which the execution statement of the source program and an address position of the instruction are correlated to each other, and the execution unit further selects the arbitrary instruction based on the extracted correlation.

22. A debugging device comprising:
a setting unit for setting a break point at an arbitrary instruction in a string of instructions that is provided in a program operated by a processor capable of executing instructions in parallel and consists of a plurality of instructions logically executable in parallel;
a correcting unit for correcting a position at which the break point is set in accordance with restrictions of the processor;
a detecting unit for detecting whether or not the execution of the instruction is halted at the corrected break point; and
a simulating unit for software-simulating a group of instructions comprising at least one of the instructions between the corrected break point and the break point before the correction when it is detected that the execution of the instruction is halted at the corrected break point.

23. A debugging device comprising:
an extracting unit for extracting at least one of the arbitrary instructions from a string of instructions that is provided in a program operated by a processor capable of executing instructions in parallel and consists of a plurality of instructions logically executable in parallel; and
a simulating unit for software-simulating the extracted arbitrary instruction.

24. The debugging device according to claim 23, wherein
the processor is generated from a source program, and
the extracting unit extracts a correlation between an execution statement of the source program and the string of instructions from a debug information in which the execution statement of the source program and an address position of the instruction are correlated to each other, and the extracting unit further extracts the arbitrary instruction based on the extracted correlation.
